(19) United States
(12) Patent Application Publication
(10) Pub. No.: US 2026/0333477 A1
(43) Pub. Date: Oct. 22, 2026

(54) METHOD FOR EXCHANGING PATH SWITCHING CAPABILITY AND DEVICE

(71) Applicant: Beijing Xiaomi Mobile Software Co., Ltd., Beijing (CN)

(72) Inventor: Jianning LIU, Beijing (CN)

(21) Appl. No.: 19/115,703

(22) PCT Filed: Sep. 30, 2022
(86) PCT No.: PCT/CN2022/123641

§ 371 Date: Mar. 26, 2025

(51) Int. Cl. H04W 76/14; H04W 4/40; H04W 8/22; H04W 92/18

(52) U.S. Cl. CPC H04W 76/14; H04W 4/40; H04W 8/22; H04W 92/18

(57) ABSTRACT

A method for exchanging path switching capability, including: a first terminal device sends a request message for establishing a direct communication to a second terminal device, the request message for establishing the direct communication indicates path switching capability of the first terminal device; and the first terminal device receives a request message for establishing the direct communication sent by the second terminal device, the request message for establishing the direct communication indicates the switching capability of the second terminal device.

### CROSS-REFERENCE TO RELATED APPLICATIONS

The present application is a U.S. National Stage of International Application No. PCT/CN2022/123641, filed on Sep. 30, 2022, the contents of all of which are incorporated herein by reference in their entireties for all purposes.

### BACKGROUND OF THE INVENTION

At present, communication between two terminal devices possibly requires a switch between a PC5 direct communication path and a Uu direct communication path.

### SUMMARY OF THE INVENTION

The present disclosure relates to the technical field of communication, and provides a method for exchanging path switching capability and a device.

In a first aspect, a method for exchanging path switching capability is provided in the embodiments of the present disclosure. The method is performed by a first terminal device and includes: sending a request message for establishing a direct communication to a second terminal device, where the request message for establishing the direct communication indicates path switching capability of the first terminal device; and receiving a response message for establishing the direct communication sent by the second terminal device, where the response message for establishing the direct communication indicates path switching capability of the second terminal device.

In a second aspect, another method for exchanging path switching capability is provided in the embodiments of the present disclosure. The method is performed by a second terminal device and includes: receiving a request message for establishing a direct communication sent by a first terminal device, where the request message for establishing the direct communication indicates path switching capability of the first terminal device; and sending a response message for establishing the direct communication to the first terminal device, where the response message for establishing the direct communication indicates path switching capability of the second terminal device.

In a third aspect, a communication device is provided in the embodiments of the present disclosure. The communication device includes one or more processors and a memory; where the memory stores a computer program, and the one or more processors when being collectively configured to execute the computer program stored in the memory, cause the communication device to:

send a request message for establishing a direct communication to a second terminal device, wherein the request message for establishing the direct communication indicates path switching capability of the first terminal device; and

receive a response message for establishing the direct communication sent by the second terminal device, wherein the response message for establishing the direct communication indicates path switching capability of the second terminal device.

In a fourth aspect, a communication device is provided in the embodiments of the present disclosure. The communication device includes one or more processors and a memory; where the memory stores a computer program, and the one or more processors when being collectively configured to execute the computer program stored in the memory, cause the communication device to perform the method in the above second aspect.

### BRIEF DESCRIPTION OF DRAWINGS

In order to describe the technical solutions in embodiments of the present disclosure or in the background art more clearly, the accompanying drawings required to be used in the embodiments of the present disclosure or in the background art are described below.

FIG. 1 is a schematic diagram of an architecture of a communication system according to an embodiment of the present disclosure;

FIG. 2 is a schematic diagram of a path switching process;

FIG. 3 is a schematic flowchart of a method for exchanging path switching capability according to an embodiment of the present disclosure;

FIG. 4 is a schematic flowchart of a method for exchanging path switching capability according to another embodiment of the present disclosure;

FIG. 5 is a schematic flowchart of a method for exchanging path switching capability according to another embodiment of the present disclosure;

FIG. 6 is a schematic flowchart of a method for exchanging path switching capability according to another embodiment of the present disclosure;

FIG. 7 is a schematic diagram of a path switching process according to an embodiment of the present disclosure;

FIG. 8 is a schematic flowchart of a method for exchanging path switching capability according to an embodiment of the present disclosure;

FIG. 9 is a schematic flowchart of a method for exchanging path switching capability according to another embodiment of the present disclosure;

FIG. 10 is a schematic flowchart of a method for exchanging path switching capability according to another embodiment of the present disclosure;

FIG. 11 is a schematic flowchart of a method for exchanging path switching capability according to another embodiment of the present disclosure;

FIG. 12 is a schematic structural diagram of a communication device according to an embodiment of the present disclosure;

FIG. 13 is a schematic structural diagram of a communication device according to another embodiment of the present disclosure; and

FIG. 14 is a schematic structural diagram of a chip according to an embodiment of the present disclosure.

### DETAILED DESCRIPTION OF THE INVENTION

In order to better understand a method for exchanging path switching capability disclosed in embodiments of the present disclosure, a communication system applicable to the embodiments of the present disclosure is first described below.

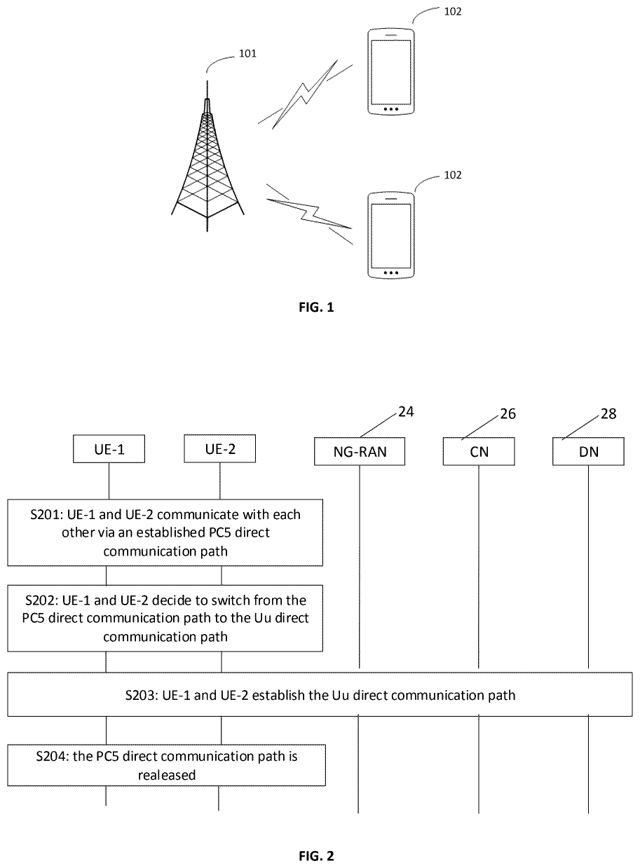

With reference to FIG. 1, FIG. 1 is a schematic diagram of an architecture of a communication system according to an embodiment of the present disclosure. The communication system can include, but is not limited to, a network device and a terminal device. Numbers and forms of the devices shown in FIG. 1 are merely illustrative, and do not limit the embodiments of the present disclosure. In practical application, two or more network devices and two or more terminal devices can be included. The communication system shown in FIG. 1 includes a network device 101 and two terminal devices 102 as an example.

It should be noted that the technical solution in the embodiments of the present disclosure can be applied to various communication systems. For example, the technical solution can be applied to a long term evolution (LTE) system, a 5th generation (5G) of mobile communication system, a 5G of new radio (NR) system, or other future novel mobile communication systems, etc.

The network device 101 in the embodiment of the present disclosure is an entity located on a network side and configured to send or receive signals. For example, the network device 101 can be an evolved node B (eNB), a transmission reception point (TRP), a next generation node B (gNB) in the NR system, a base station in other future mobile communication systems, or an access node in a wireless fidelity (WiFi) system, etc. The specific technology and the specific device form employed by the network device 101 are not limited in the embodiments of the present disclosure. The network device 101 in the embodiment of the present disclosure may be composed of a central unit (CU) and a distributed unit (DU), where the CU may also be referred to as a control unit. With a CU-DU architecture, protocol layers of the network device 101, such as the base station, may be split, functions of some protocol layers are centrally controlled by the CU, and functions of part or all of remaining protocol layers are distributed in the DU, and the DU is centrally controlled by the CU.

The terminal device 102 in the embodiment of the present disclosure is an entity located on a user side and configured to receive or send signals, such as a mobile phone. The terminal device 102 can also be referred to as a terminal, user equipment (UE), a mobile station (MS), a mobile terminal (MT), etc. The terminal device 102 can be a vehicle having a function of communication, a smart vehicle, a mobile phone, a wearable device, a pad, a computer having a function of wireless transceiving, a virtual reality (VR) terminal device, an augmented reality (AR) terminal device, a radio terminal device in industrial control, a radio terminal device in self-driving, a radio terminal device in remote medical surgery, a radio terminal device in smart grid, a radio terminal device in transportation safety, a radio terminal device in smart city, or a radio terminal device in smart home, etc. The specific technology and the specific device form employed by the terminal device 102 are not limited in the embodiment of the present disclosure.

At present, vehicle-to-everything (V2X) can support scenarios with cellular network coverage and scenarios without cellular network deployment. In terms of the specific technology, V2X can provide two communication interfaces, i.e., a PC5 interface (a direct communication interface between the terminal devices) and a Uu interface (a cellular communication interface between the terminal device and the base station). When in cellular coverage, the terminal device supporting V2X may communicate with the base station through an uplink (UL) or a downlink (DL) via the Uu interface under the control of the cellular network. The terminal device may communicate with other terminal devices through a sidelink (SL) via the PC5 interface regardless of whether there is the network coverage. The Uu interface and the PC5 interface are combined with each other for mutual support, and are jointly used for V2X service transmission, so that effective redundancy is formed to ensure communication reliability.

In some scenarios, during communication between the two terminal devices, it may be required to switch between a PC5 direct communication path and a Uu direct communication path. The PC5 direct communication path indicates a path through which the two terminal devices communicate directly via the PC5 interface. The Uu direct communication path indicates a path through which the two terminal devices communicate via the Uu interface, and may be interpreted as a path through which the two terminal devices communicate via the network device. For example, during communication between the two terminal devices through the PC5 direct communication path, in a case where one terminal device leaves for a region with cellular coverage from a region without cellular coverage, the two terminal devices may switch from the PC5 direct communication path to the Uu direct communication path for communication.

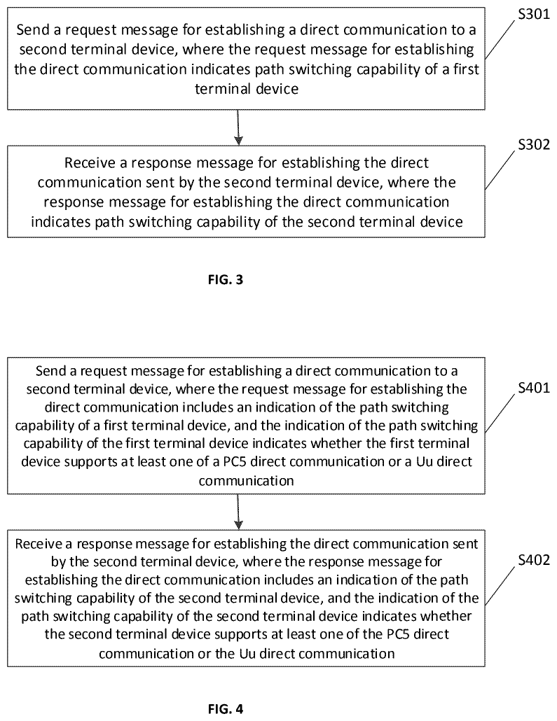

With reference to FIG. 2, UE-1 and UE-2 denote the two terminal devices respectively. The UE-1 and the UE-2 communicate with each other via an established PC5 direct communication path (S201). In some scenarios, the UE-1 and the UE-2 may decide to switch from the PC5 direct communication path to the Uu direct communication path (S202). The UE-1 and the UE-2 establish the Uu direct communication path with a next generation radio access network (NG-RAN) 24, a 5G core network (CN) 26, and a data network (DN) 28 separately (S203), and then release the PC5 direct communication path (S204). Thus, switching from the PC5 direct communication path to the Uu direct communication path is completed. The UE-1 and the UE-2 determine whether to allow switching from the PC5 direct communication path to the Uu direct communication path according to their own path switching capability, and perform a path switching process when the switching is allowed. In this way, path switching failure is likely to occur.

In view of the above problem, a method for exchanging path switching capability and a device are provided in the embodiments of the present disclosure. Thus, exchanging path switching capability can be performed between two terminal devices, so that the occurrence of path switching failure can be reduced.

It can be understood that the communication system described in the embodiments of the present disclosure is intended to describe the technical solution according to the embodiments of the present disclosure more clearly, instead of limiting the technical solution according to the embodiments of the present disclosure. As those of ordinary skill in the art know, with evolution of the system architecture and emergence of new service scenario, the technical solution according to the embodiments of the present disclosure is also applicable to similar technical problems.

It should be noted that the method for exchanging path switching capability according to any embodiment of the present disclosure can be performed independently, performed in combination with possible implementation methods in other embodiments, or performed in combination with any technical solution in the related art. A first terminal device mentioned in the embodiments of the present disclosure may indicate one of the terminal devices 102 in the communication system, and a second terminal device may indicate the other one of the terminal devices 102 in the communication system.

The method for exchanging path switching capability and the device provided by the present disclosure are described in detail below with reference to the accompanying drawings.

With reference to FIG. 3, FIG. 3 is a schematic flowchart of a method for exchanging path switching capability according to an embodiment of the present disclosure. The method for exchanging path switching capability is performed by the first terminal device. As shown in FIG. 3, the method may include, but is not limited to:

S301: a request message for establishing a direct communication is sent to a second terminal device, where the request message for establishing the direct communication indicates path switching capability of the first terminal device.

In the embodiment of the present disclosure, the request message for establishing the direct communication is sent by the first terminal device, so as to establish the communication connection between the first terminal device and the second terminal device.

Optionally, the request message for establishing the direct communication is configured to establish a PC5 direct communication path between the first terminal device and the second terminal device. Or the request message for establishing the direct communication is configured to establish a Uu direct communication path between the first terminal device and the second terminal device. The PC5 direct communication path or the Uu direct communication path is configured to transmit data of all proximity-based services (ProSe) or a specific ProSe.

Optionally, the path switching capability indicated by the request message for establishing the direct communication is for all ProSe or a specific ProSe of the first terminal device. In other words, the first terminal device uses same path switching capability for the all ProSe. Or the first terminal device uses same path switching capability for the specific ProSe.

In the embodiment of the present disclosure, the request message for establishing the direct communication may not only be configured to establish the communication connection between the first terminal device and the second terminal device, but may also be configured to indicate the path switching capability of the first terminal device to the second terminal device.

The path switching capability of the first terminal device indicates whether the first terminal device supports a PC5 direct communication and/or a Uu direct communication. The PC5 direct communication may be interpreted as direct communication between two terminal devices via the PC5 interface. The Uu direct communication may be interpreted as communication between two terminal devices via the Uu interface, i.e., communication between the two terminal devices via the network device.

The path switching capability of the first terminal device may be provided for the first terminal device through a policy control function (PCF), or may be pre-configured in the first terminal device. The PCF is a unified policy framework that provides policy rules for controlling plane functions.

It can be understood that in a case where the first terminal device supports the PC5 direct communication, the path switching capability of the first terminal device may support switching to the PC5 direct communication path. In a case where the first terminal device supports the Uu direct communication, the path switching capability of the first terminal device may support switching to the Uu direct communication path. In a case where the first terminal device supports the PC5 direct communication and the Uu direct communication, the path switching capability of the first terminal device may support switching between the PC5 direct communication path and the Uu direct communication path.

S302: a response message for establishing the direct communication sent by the second terminal device is received, where the response message for establishing the direct communication indicates path switching capability of the second terminal device.

In the embodiment of the present disclosure, in a case where the second terminal device receives the request message for establishing the direct communication sent by the first terminal device, the second terminal device may send the response message for establishing the direct communication to the first terminal device. Correspondingly, the first terminal device may receive the response message for establishing the direct communication sent by the second terminal device, so as to establish the communication connection between the first terminal device and the second terminal device.

Optionally, the response message for establishing the direct communication is configured to establish the PC5 direct communication path between the first terminal device and the second terminal device. Or the response message for establishing the direct communication is configured to establish the Uu direct communication path between the first terminal device and the second terminal device.

Optionally, the path switching capability indicated by the response message for establishing the direct communication is for all ProSe or a specific ProSe of the second terminal device. In other words, the second terminal device uses same path switching capability for the all ProSe. Or the second terminal device uses same path switching capability for the specific ProSe.

In the embodiment of the present disclosure, the response message for establishing the direct communication may not only be configured to establish the communication connection between the first terminal device and the second terminal device, but may also be configured to indicate the path switching capability of the second terminal device to the first terminal device.

The path switching capability of the second terminal device indicates whether the second terminal device supports the PC5 direct communication and/or the Uu direct communication.

The path switching capability of the second terminal device may be provided for the second terminal device through a PCF, or may be pre-configured in the second terminal device.

It can be understood that in a case where the second terminal device supports the PC5 direct communication, the path switching capability of the first terminal device may support switching to the PC5 direct communication path. In a case where the second terminal device supports the Uu direct communication, the path switching capability of the second terminal device may support switching to the Uu direct communication path. In a case where the second terminal device supports the PC5 direct communication and the Uu direct communication, the path switching capability of the second terminal device may support switching between the PC5 direct communication path and the Uu direct communication path.

It should be noted that before performing S301 and S302, the first terminal device and the second terminal device need to perform network registration, so that network authentication and authorization are performed on the first terminal device and the second terminal device.

Since the first terminal device and the second terminal device may perform exchanging path switching capability, it is possible to determine whether to allow switching from one direct communication path to the other direct communication path, according to the path switching capability of the two terminal devices. Thus, the occurrence of path switching failure can be reduced.

In the method for exchanging path switching capability according to the embodiments of the present disclosure, the first terminal device may send the request message for establishing the direct communication to the second terminal device, where the request message for establishing the direct communication indicates the path switching capability of the first terminal device; and receive the response message for establishing the direct communication sent by the second terminal device, where the response message for establishing the direct communication indicates the path switching capability of the second terminal device. Thus, exchanging path switching capability can be performed between the two terminal devices, so that the occurrence of path switching failure can be reduced.

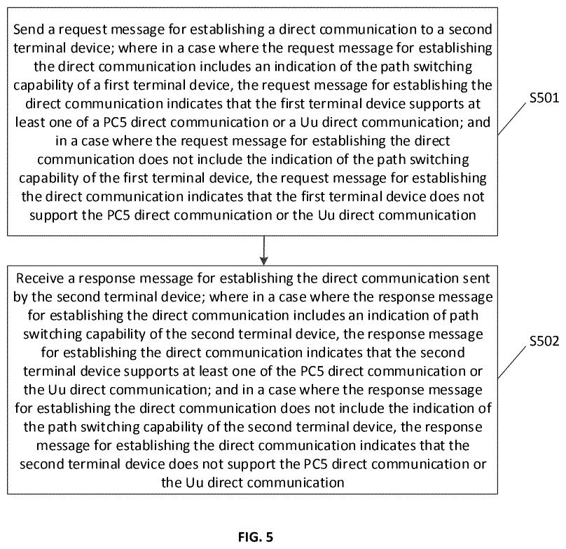

With reference to FIG. 4, FIG. 4 is a schematic flowchart of a method for exchanging path switching capability according to another embodiment of the present disclosure. The method for exchanging path switching capability may be performed by the first terminal device. As shown in FIG. 4, the method may include, but is not limited to:

S401: the request message for establishing the direct communication is sent to the second terminal device, where the request message for establishing the direct communication includes an indication of the path switching capability of the first terminal device, and the indication of the path switching capability of the first terminal device indicates whether the first terminal device supports the PC5 direct communication and/or the Uu direct communication.

In the embodiment of the present disclosure, the request message for establishing the direct communication is sent by the first terminal device, so as to establish the communication connection between the first terminal device and the second terminal device.

Optionally, the request message for establishing the direct communication is configured to establish the PC5 direct communication path between the first terminal device and the second terminal device. Or the request message for establishing the direct communication is configured to establish the Uu direct communication path between the first terminal device and the second terminal device.

In the embodiment of the present disclosure, the request message for establishing the direct communication may not only be configured to establish the communication connection between the first terminal device and the second terminal device, but may also be configured to indicate the path switching capability of the first terminal device to the second terminal device.

In some implementations, the indication of the path switching capability of the first terminal device may be carried in the request message for establishing the direct communication, and whether the first terminal device supports the PC5 direct communication and/or the Uu direct communication may be indicated to the second terminal device through the indication of the path switching capability.

In some implementations, the indication of the path switching capability of the first terminal device may include a switching indication of the first terminal device, and the switching indication indicates whether the first terminal device supports switching from the PC5 direct communication path to the Uu direct communication path, and/or switching from the Uu direct communication path to the PC5 direct communication path.

It can be understood that in a case where the switching indication of the first terminal device indicates that the first terminal device supports switching from the PC5 direct communication path to the Uu direct communication path, it may be determined that the path switching capability of the first terminal device supports the first terminal device in switching from the PC5 direct communication path to the Uu direct communication path. In a case where the switching indication of the first terminal device indicates that the first terminal device supports switching from the Uu direct communication path to the PC5 direct communication path, it may be determined that the path switching capability of the first terminal device supports the first terminal device in switching from the Uu direct communication path to the PC5 direct communication path. In a case where the switching indication of the first terminal device indicates that the first terminal device supports switching from the PC5 direct communication path to the Uu direct communication path and switching from the Uu direct communication path to the PC5 direct communication path, it may be determined that the path switching capability of the first terminal device supports the first terminal device in switching from the PC5 direct communication path to the Uu direct communication path and switching from the Uu direct communication to the PC5 direct communication.

It can be understood that in the instance of the present disclosure, the indication of the path switching capability of the first terminal device is added to an original request message for establishing the direct communication. For example, the indication of the path switching capability may be added to an idle information field of the request message for establishing the direct communication. For another example, a designated information field of the request message for establishing the direct communication may be multiplexed, and the indication of the path switching capability may be added to the designated information field. Thus, it is possible to indicate the path switching capability of the first terminal device to the second terminal device without adding interaction signaling between the first terminal device and the second terminal device, so that signaling resources are saved on.

Optionally, the request message for establishing the direct communication may further include at least one of: security information of the first terminal device or user information of the first terminal device.

S402: the response message for establishing the direct communication sent by the second terminal device is received, where the response message for establishing the direct communication includes an indication of the path switching capability of the second terminal device, and the indication of the path switching capability of the second terminal device indicates whether the second terminal device supports the PC5 direct communication and/or the Uu direct communication.

In the embodiment of the present disclosure, in a case where the second terminal device receives the request message for establishing the direct communication sent by the first terminal device, the second terminal device may send the response message for establishing the direct communication to the first terminal device. Correspondingly, the first terminal device may receive the response message for establishing the direct communication sent by the second terminal device, so as to establish the communication connection between the first terminal device and the second terminal device.

Optionally, the response message for establishing the direct communication is configured to establish the PC5 direct communication path between the first terminal device and the second terminal device. Or the response message for establishing the direct communication is configured to establish the Uu direct communication path between the first terminal device and the second terminal device.

In the embodiment of the present disclosure, the response message for establishing the direct communication may not only be configured to establish the communication connection between the first terminal device and the second terminal device, but may also be configured to indicate the path switching capability of the second terminal device to the first terminal device.

In some implementations, the indication of the path switching capability of the second terminal device may be carried in the response message for establishing the direct communication, and whether the second terminal device supports the PC5 direct communication and/or the Uu direct communication may be indicated to the first terminal device through the indication of the path switching capability.

In some implementations, the indication of the path switching capability of the second terminal device may include a switching indication of the second terminal device, and the switching indication indicates whether the second terminal device supports switching from the PC5 direct communication path to the Uu direct communication path, and/or switching from the Uu direct communication path to the PC5 direct communication path.

It can be understood that in a case where the switching indication of the second terminal device indicates that the second terminal device supports switching from the PC5 direct communication path to the Uu direct communication path, it may be determined that the path switching capability of the second terminal device supports the second terminal device in switching from the PC5 direct communication path to the Uu direct communication path. In a case where the switching indication of the second terminal device indicates that the second terminal device supports switching from the Uu direct communication path to the PC5 direct communication path, it may be determined that the path switching capability of the second terminal device supports the second terminal device in switching from the Uu direct communication path to the PC5 direct communication path. In a case where the switching indication of the second terminal device indicates that the second terminal device supports switching from the PC5 direct communication path to the Uu direct communication path and switching from the Uu direct communication path to the PC5 direct communication path, it can be determined that the path switching capability of the second terminal device supports the second terminal device in switching from the PC5 direct communication path to the Uu direct communication path and switching from the Uu direct communication path to the PC5 direct communication path.

It can be understood that in the instance of the present disclosure, the indication of the path switching capability is added to an original response message for establishing the direct communication. For example, the indication of the path switching capability may be added to an idle information field of the response message for establishing the direct communication. For another example, a designated information field of the response message for establishing the direct communication may be multiplexed, and the indication of the path switching capability may be added to the designated information field. Thus, it is possible to indicate the path switching capability of the second terminal device to the first terminal device without adding interaction signaling between the first terminal device and the second terminal device, so that signaling resources are saved on.

Optionally, the response message for establishing the direct communication sent by the second terminal device may further include at least one of: security information of the second terminal device or user information of the first terminal device.

In the embodiment of the present disclosure, after receiving the response message for establishing the direct communication, the first terminal device may determine whether the second terminal device supports the PC5 direct communication and/or the Uu direct communication according to the indication of the path switching capability of the second terminal device. In other words, according to the response message for establishing the direct communication, the first terminal device may determine that the second terminal device may support the PC5 direct communication, but does not support the Uu direct communication; alternatively, the second terminal device does not support the PC5 direct communication, but supports the Uu direct communication; alternatively, the second terminal device supports the PC5 direct communication and the Uu direct communication; and alternatively, the second terminal device does not support the PC5 direct communication or the Uu direct communication.

In the embodiment of the present disclosure, after receiving the response message for establishing the direct communication, the first terminal device may determine that the second terminal device supports switching from the PC5 direct communication path to the Uu direct communication path, and/or switching from the Uu direct communication path to the PC5 direct communication path according to the switching indication included in the indication of the path switching capability of the second terminal device. In other words, according to the response message for establishing the direct communication, the first terminal device may determine that the second terminal device may support switching from the PC5 direct communication path to the Uu direct communication path, but does not support switching from the Uu direct communication path to the PC5 direct communication path; alternatively, the second terminal device does not support switching from the PC5 direct communication path to the Uu direct communication path, but supports switching from the Uu direct communication path to the PC5 direct communication path; alternatively, the second terminal device supports switching from the PC5 direct communication path to the Uu direct communication path and switching from the Uu direct communication path to the PC5 direct communication path; and alternatively, the second terminal device does not support switching from the PC5 direct communication path to the Uu direct communication path or switching from the Uu direct communication path to the PC5 direct communication path.

As a possible implementation, the indication of the path switching capability of the first terminal device and the second terminal device may each include first indication information and/or second indication information. The first indication information indicates whether a corresponding terminal device supports the PC5 direct communication; and the second indication information indicates whether the corresponding terminal device supports the Uu direct communication.

Optionally, the indication of the path switching capability includes the first indication information, and it is determined that the corresponding terminal device supports or does not support the PC5 direct communication according to the first indication information. For example, when a value of the first indication information included in the indication of the path switching capability is 1, it may be determined that the corresponding terminal device supports the PC5 direct communication. When the value of the first indication information included in the indication of the path switching capability is 0, it may be determined that the corresponding terminal device does not support the PC5 direct communication. In the implementation, since the indication of the path switching capability only includes the first indication information, the corresponding terminal device does not support the Uu direct communication by default.

Optionally, the indication of the path switching capability includes the second indication information, and it is determined that the corresponding terminal equipment supports or does not support the Uu direct communication according to the second indication information. For example, when a value of the second indication information included in the indication of the path switching capability is 1, it may be determined that the corresponding terminal device supports the Uu direct communication. When the value of the second indication information included in the indication of the path switching capability is 0, it may be determined that the corresponding terminal device does not support the Uu direct communication. In the implementation, since the indication of the path switching capability only includes the second indication information, the corresponding terminal device does not support the PC5 direct communication by default.

Optionally, the indication of the path switching capability includes the first indication information and the second indication information, it is determined whether the corresponding terminal device supports the PC5 direct communication according to the first indication information, and it is determined whether the corresponding terminal device supports the Uu direct communication according to the second indication information. For example, if the indication of the path switching capability is “11”, it may be determined that the corresponding terminal device supports the PC5 direct communication and the Uu direct communication. If the indication of the path switching capability is “10”, it may be determined that the corresponding terminal device supports the PC5 direct communication, but does not support the Uu direct communication. If the indication of the path switching capability is “01”, it may be determined that the corresponding terminal device does not support the PC5 direct communication, but supports the Uu direct communication. If the indication of the path switching capability is “00”, it may be determined that the corresponding terminal device does not support the PC5 direct communication or the Uu direct communication.

As another possible implementation, the indication of the path switching capability of the first terminal device and the second terminal device may include an index value, and the index value may indicate a combination condition where whether the corresponding terminal device supports the PC5 direct communication and the Uu direct communication. For example, an index value 1 may indicate that the corresponding terminal device supports the PC5 direct communication and the Uu direct communication. An index value 2 may indicate that the corresponding terminal device supports the PC5 direct communication, but does not support the Uu direct communication. An index value 3 may indicate that the corresponding terminal device does not support the PC5 direct communication, but supports the Uu direct communication. An index value 4 may indicate that the corresponding terminal device does not support the PC5 direct communication or the Uu direct communication. The first terminal device may determine the path switching capability of the second terminal device based on the index value carried in the response message for establishing the direct communication.

It should be noted that the above schematic description of the indication of the path switching capability is applicable to the indication of the path switching capability of the first terminal device and the indication of the path switching capability of the second terminal device.

It should be noted that before performing S401 and S402, the first terminal device and the second terminal device need to perform network registration, so that network authentication and authorization are performed on the first terminal device and the second terminal device.

In the method for exchanging path switching capability according to the embodiments of the present disclosure, the first terminal device may send the request message for establishing the direct communication to the second terminal device, where the request message for establishing the direct communication includes the indication of the path switching capability of the first terminal device, and the indication of the path switching capability of the first terminal device indicates whether the first terminal device supports the PC5 direct communication and/or the Uu direct communication. The first terminal device may also receive the response message for establishing the direct communication sent by the second terminal device, where the response message for establishing the direct communication includes the indication of the path switching capability of the second terminal device, and the indication of the path switching capability of the second terminal device indicates whether the second terminal device supports the PC5 direct communication and/or the Uu direct communication. Thus, exchanging path switching capability can be performed between the two terminal devices, so that the occurrence of path switching failure can be reduced.

With reference to FIG. 5, FIG. 5 is a schematic flowchart of a method for exchanging path switching capability according to another embodiment of the present disclosure. The method for exchanging path switching capability may be performed by the first terminal device. As shown in FIG. 5, the method may include, but is not limited to:

S501: the request message for establishing the direct communication is sent to the second terminal device. In a case where the request message for establishing the direct communication includes the indication of the path switching capability of the first terminal device, the request message for establishing the direct communication indicates that the first terminal device supports the PC5 direct communication and/or the Uu direct communication. In a case where the request message for establishing the direct communication does not include the indication of the path switching capability of the first terminal device, the request message for establishing the direct communication indicates that the first terminal device does not support the PC5 direct communication or the Uu direct communication.

In the embodiment of the present disclosure, the request message for establishing the direct communication is sent by the first terminal device, so as to establish the communication connection between the first terminal device and the second terminal device.

Optionally, the request message for establishing the direct communication is configured to establish the PC5 direct communication path between the first terminal device and the second terminal device. Or the request message for establishing the direct communication is configured to establish the Uu direct communication path between the first terminal device and the second terminal device.

In the embodiment of the present disclosure, the request message for establishing the direct communication may not only be configured to establish the communication connection between the first terminal device and the second terminal device, but may also be configured to indicate the path switching capability of the first terminal device to the second terminal device.

In some implementations, the indication of the path switching capability of the first terminal device may be included in the request message for establishing the direct communication, so as to indicate to the second terminal device that the first terminal device supports the PC5 direct communication and/or the Uu direct communication, i.e., indicate to the second terminal device that the first terminal device supports the PC5 direct communication or the Uu direct communication, or supports the PC5 direct communication and the Uu direct communication. The indication of the path switching capability of the first terminal device may not be included in the request message for establishing the direct communication, so as to indicate to the second terminal device that the first terminal device does not support the PC5 direct communication or the Uu direct communication. Thus, it is possible to indicate the path switching capability of the first terminal device to the second terminal device without adding interaction signaling between the first terminal device and the second terminal device, so that signaling resources are saved on.

In some implementations, the indication of the path switching capability of the first terminal device may be included in the request message for establishing the direct communication, and the switching indication of the first terminal device may be included in the indication of the path switching capability of the first terminal device, so as to indicate to the second terminal device that the first terminal device supports switching from the PC5 direct communication path to the Uu direct communication path, and/or switching from the Uu direct communication path to the PC5 direct communication path. The indication of the path switching capability of the first terminal device may be included in the request message for establishing the direct communication, and the switching indication of the first terminal device may not be included in the indication of the path switching capability of the first terminal device, so as to indicate to the second terminal device that the first terminal device does not support switching from the PC5 direct communication path to the Uu direct communication path or switching from the Uu direct communication path to the PC5 direct communication path.

In some implementations, the indication of the path switching capability of the first terminal device may be included in the request message for establishing the direct communication, so as to indicate to the second terminal device that the first terminal device supports switching from the PC5 direct communication path to the Uu direct communication path, and/or switching from the Uu direct communication path to the PC5 direct communication path. The indication of the path switching capability of the first terminal device may not be included in the request message for establishing the direct communication, so as to indicate to the second terminal device that the first terminal device does not support switching from the PC5 direct communication path to the Uu direct communication path or switching from the Uu direct communication path to the PC5 direct communication path.

Optionally, the request message for establishing the direct communication may further include at least one of: security information of the first terminal device or user information of the first terminal device.

S502: the response message for establishing the direct communication sent by the second terminal device is received. In a case where the response message for establishing the direct communication includes the indication of the path switching capability of the second terminal device, the response message for establishing the direct communication indicates that the second terminal device supports the PC5 direct communication and/or the Uu direct communication. In a case where the response message for establishing the direct communication does not include the indication of the path switching capability of the second terminal device, the response message for establishing the direct communication indicates that the second terminal device does not support the PC5 direct communication or the Uu direct communication.

In the embodiment of the present disclosure, in a case where the second terminal device receives the request message for establishing the direct communication sent by the first terminal device, the second terminal device may send the response message for establishing the direct communication to the first terminal device. Correspondingly, the first terminal device may receive the response message for establishing the direct communication sent by the second terminal device, so as to establish the communication connection between the first terminal device and the second terminal device.

Optionally, the response message for establishing the direct communication is configured to establish the PC5 direct communication path between the first terminal device and the second terminal device. Or the response message for establishing the direct communication is configured to establish the Uu direct communication path between the first terminal device and the second terminal device.

In the embodiment of the present disclosure, the response message for establishing the direct communication may not only be configured to establish the communication connection between the first terminal device and the second terminal device, but may also be configured to indicate the path switching capability of the second terminal device to the first terminal device.

In some implementations, the indication of the path switching capability of the second terminal device may be included in the response message for establishing the direct communication, so as to indicate to the first terminal device that the second terminal device supports the PC5 direct communication and/or the Uu direct communication, i.e., indicate to the first terminal device that the second terminal device supports the PC5 direct communication or the Uu direct communication, or supports the PC5 direct communication and the Uu direct communication. The indication of the path switching capability of the second terminal device may not be included in the response message for establishing the direct communication, so as to indicate to the first terminal device that the second terminal device does not support the PC5 direct communication or the Uu direct communication. Thus, it is possible to indicate the path switching capability of the second terminal device to the first terminal device without adding interaction signaling between the first terminal device and the second terminal device, so that signaling resources are saved on.

In some implementations, the indication of the path switching capability of the second terminal device may be included in the response message for establishing the direct communication, and the switching indication of the second terminal device may be included in the indication of the path switching capability of the second terminal device, so as to indicate to the first terminal device that the second terminal device supports switching from the PC5 direct communication path to the Uu direct communication path, and/or switching from the Uu direct communication path to the PC5 direct communication path. The indication of the path switching capability of the second terminal device may be included in the response message for establishing the direct communication, and the switching indication of the second terminal device may not be included in the indication of the path switching capability of the second terminal device, so as to indicate to the first terminal device that the second terminal device does not support switching from the PC5 direct communication path to the Uu direct communication path or switching from the Uu direct communication path to the PC5 direct communication path.

In some implementations, the indication of the path switching capability of the second terminal device may be included in the response message for establishing the direct communication, so as to indicate to the first terminal device that the second terminal device supports switching from the PC5 direct communication path to the Uu direct communication path, and/or switching from the Uu direct communication path to the PC5 direct communication path. The indication of the path switching capability of the second terminal device may not be included in the response message for establishing the direct communication, so as to indicate to the first terminal device that the second terminal device does not support switching from the PC5 direct communication path to the Uu direct communication path or switching from the Uu direct communication path to the PC5 direct communication path.

Optionally, the response message for establishing the direct communication sent by the second terminal device may further include at least one of: security information of the second terminal device or user information of the first terminal device.

In the embodiment of the present disclosure, after receiving the response message for establishing the direct communication, the first terminal device may determine the path switching capability of the second terminal device according to whether the indication of the path switching capability of the second terminal device is included in the response message for establishing the direct communication. In a case where the indication of the path switching capability of the second terminal device is included in the response message for establishing the direct communication, it may be determined that the path switching capability of the second terminal device is that the second terminal device supports the PC5 direct communication; alternatively, the second terminal device supports the Uu direct communication; and alternatively, the second terminal device supports the PC5 direct communication and the Uu direct communication. In a case where the indication of the path switching capability of the second terminal device is not included in the response message for establishing the direct communication, it may be determined that the path switching capability of the second terminal device is that the second terminal device does not support the PC5 direct communication or the Uu direct communication.

As a possible implementation, in a case where the indication of the path switching capability includes third indication information, the indication of the path switching capability of the first terminal device and the second terminal device may indicate that the corresponding terminal device supports the PC5 direct communication. In a case where the indication of the path switching capability does not include the third indication information, the indication of the path switching capability of the first terminal device and the second terminal device may indicate that the corresponding terminal device does not support the PC5 direct communication.

As a possible implementation, in a case where the indication of the path switching capability includes fourth indication information, the indication of the path switching capability of the first terminal device and the second terminal device may indicate that the corresponding terminal device supports the Uu direct communication. In a case where the indication of the path switching capability does not include the fourth indication information, the indication of the path switching capability of the first terminal device and the second terminal device may indicate that the corresponding terminal device does not support the Uu direct communication.

Optionally, in a case where the indication of the path switching capability includes the third indication information, but does not include the fourth indication information, it may be determined that the corresponding terminal device supports the PC5 direct communication, but does not support the Uu direct communication. Optionally, in a case where the indication of the path switching capability does not include the third indication information, but includes the fourth indication information, it may be determined that the corresponding terminal device does not support the PC5 direct communication, but supports the Uu direct communication. Optionally, in a case where the indication of the path switching capability includes the third indication information and the fourth indication information, it may be determined that the corresponding terminal device supports the PC5 direct communication and the Uu direct communication. Optionally, in a case where the indication of the path switching capability does not include the third indication information or the fourth indication information, it may be determined that the corresponding terminal device does not support the PC5 direct communication or the Uu direct communication.

It should be noted that the above schematic description of the indication of the path switching capability is applicable to the indication of the path switching capability of the first terminal device and the indication of the path switching capability of the second terminal device.

It should be noted that before performing S501 and S502, the first terminal device and the second terminal device need to perform network registration, so that network authentication and authorization are performed on the first terminal device and the second terminal device.

In the method for exchanging path switching capability according to the embodiments of the present disclosure, the first terminal device may send the request message for establishing the direct communication to the second terminal device. In a case where the request message for establishing the direct communication includes the indication of the path switching capability of the first terminal device, the request message for establishing the direct communication indicates that the first terminal device supports the PC5 direct communication and/or the Uu direct communication. In a case where the request message for establishing the direct communication does not include the indication of the path switching capability of the first terminal device, the request message for establishing the direct communication indicates that the first terminal device does not support the PC5 direct communication or the Uu direct communication. The first terminal device may also receive the response message for establishing the direct communication sent by the second terminal device. In a case where the response message for establishing the direct communication includes the indication of the path switching capability of the second terminal device, the response message for establishing the direct communication indicates that the second terminal device supports the PC5 direct communication and/or the Uu direct communication. In a case where the response message for establishing the direct communication does not include the indication of the path switching capability of the second terminal device, the response message for establishing the direct communication indicates that the second terminal device does not support the PC5 direct communication or Uu direct communication. Thus, exchanging path switching capability can be performed between two terminal devices, so that the occurrence of path switching failure can be reduced.

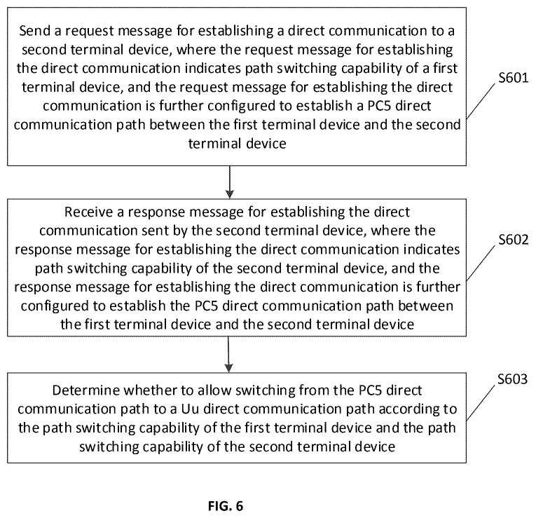

With reference to FIG. 6, FIG. 6 is a schematic flowchart of a method for exchanging path switching capability according to another embodiment of the present disclosure. The method for exchanging path switching capability may be performed by the first terminal device. As shown in FIG. 6, the method may include, but is not limited to:

S601: the request message for establishing the direct communication is sent to the second terminal device, where the request message for establishing the direct communication indicates path switching capability of the first terminal device, and the request message for establishing the direct communication is further configured to establish the PC5 direct communication path between the first terminal device and the second terminal device.

S602: the response message for establishing the direct communication sent by the second terminal device is received, where the response message for establishing the direct communication indicates path switching capability of the second terminal device, and the response message for establishing the direct communication is further configured to establish the PC5 direct communication path between the first terminal device and the second terminal device.

Reference can be made to the description of relevant contents such as S301-S302, S401-S402, or S501-S502 in the above embodiment for the specific description of S601-S602, which will not be repeated here.

S603: determining whether to allow switching from the PC5 direct communication path to the Uu direct communication path, according to the path switching capability of the first terminal device and the path switching capability of the second terminal device.

In the embodiment of the present disclosure, the request message for establishing the direct communication and the response message for establishing the direct communication are configured to establish the PC5 direct communication path between the first terminal device and the second terminal device. After receiving the response message for establishing the direct communication, the first terminal device may start to establish the PC5 direct communication path with the second terminal device. After the PC5 direct communication path is established between the first terminal device and the second terminal device, the PC5 direct communication may be performed between the first terminal device and the second terminal device.

In some implementations, during communication between the first terminal device and the second terminal device through the PC5 direct communication path, the first terminal device may measure a signal quality of the PC5 direct communication path in real time. When it is measured that the signal quality of the PC5 direct communication path does not satisfy a signal quality condition, in order to ensure a communication quality between the first terminal device and the second terminal device, the first terminal device may attempt to switch from the PC5 direct communication path to the Uu direct communication path.

In some implementations, the first terminal device may actively interrupt the PC5 direct communication path with the second terminal device. In this case, the first terminal device also needs to switch from the PC5 direct communication path to the Uu direct communication path.

In the embodiment of the present disclosure, before switching from the PC5 direct communication path to the Uu direct communication path, the first terminal device may determine whether to allow switching from the PC5 direct communication path to the Uu direct communication path according to the respective path switching capability of the first terminal device and the second terminal device.

In some implementations, during communication between the first terminal device and the second terminal device through the PC5 direct communication path, in a case where the first terminal device supports the Uu direct communication and the second terminal device supports the Uu direct communication, it is determined to allow switching from the PC5 direct communication path to the Uu direct communication path. In a case where the first terminal device does not support the Uu direct communication, or the second terminal device does not support the Uu direct communication, it is determined not to allow switching from the PC5 direct communication path to the Uu direct communication path.

In some implementations, during communication between the first terminal device and the second terminal device through the PC5 direct communication path, in a case where the first terminal device supports the Uu direct communication, the second terminal device supports the Uu direct communication, the first terminal device supports switching from the PC5 direct communication path to the Uu direct communication path, and the second terminal device supports switching from the PC5 direct communication path to the Uu direct communication path, it is determined to allow switching from the PC5 direct communication path to the Uu direct communication path. In a case where the first terminal device does not support the Uu direct communication, alternatively, the second terminal device does not support the Uu direct communication, alternatively, the first terminal device does not support switching from the PC5 direct communication path to the Uu direct communication path, and alternatively, the second terminal device does not support switching from the PC5 direct communication path to the Uu direct communication path, it is determined not to allow switching from the PC5 direct communication path to the Uu direct communication path.

In some implementations, in a case where it is determined not to allow switching from the PC5 direct communication path to the Uu direct communication path, no path switching is performed, and a reminder may be made at the first terminal device. In a case where it is determined to allow switching from the PC5 direct communication path to the Uu direct communication path, the first terminal device may perform the following steps: creating a protocol data unit (PDU) session for establishing the Uu direct communication path; and sending a first switching notification message to the second terminal device for noticing the second terminal device to create the PDU session for establishing the Uu direct communication path.

It can be understood that the Uu direct communication path indicates that the first terminal device communicates with the second terminal device through the network device. The first terminal device and the second terminal device need to establish part of the Uu direct communication path with the network device separately. The network device connects a Uu direct communication path section corresponding to the first terminal device to a Uu direct communication path section corresponding to the second terminal device, so that the Uu direct communication path between the first terminal device and the second terminal device is formed.

In the embodiment of the present disclosure, the first terminal device may create the PDU session, perform a PDU session process with the network device, and establish the Uu direct communication path section between the first terminal device and the network device in the PDU session process. The Uu direct communication path section is a communication path established between the first terminal device and a user plane function (UPF) of the core network through a radio access network (RAN), and may be marked as a UE1-RAN-UPF.

In the embodiment of the present disclosure, in a case where it is determined to allow switching from the PC5 direct communication path to the Uu direct communication path, the first terminal device may also need to send the first switching notification message to the second terminal device, where the first switching notification message instructs the second terminal device to create the PDU session with the network device for establishing the Uu direct communication path. Correspondingly, the second terminal device may create the PDU session according to the first switching notification message, perform the PDU session process with the network device, and establish the Uu direct communication path section between the second terminal device and the network device in the PDU session process. The Uu direct communication path section is a communication path established between the second terminal device and a UPF (UPF2) of the core network through the RAN, and may be marked as a UE2-RAN-UPF (UPF2).

After the first terminal device and the second terminal device establish the Uu direct communication path, the Uu direct communication path between the first terminal device and the second terminal device, i.e., UE1-RAN-UPF (URF2)-RAN-UE2 may be formed by connecting the UE1-RAN-UPF and the UE2-RAN-UPF.

After the Uu direct communication path is established, the first terminal device switches from the PC5 direct communication path to the Uu direct communication path, and continues communicating with the second terminal device through the Uu direct communication path.

It can be understood that after switching from the PC5 direct communication path to the Uu direct communication path between the first terminal device and the second terminal device, resources may be saved on by releasing the PC5 direct communication path.

In some implementations, in a case where it is determined to allow switching from the PC5 direct communication path to the Uu direct communication path, the second terminal device may perform the following steps: creating the protocol data unit (PDU) session for establishing the Uu direct communication path; and sending a second switching notification message to the first terminal device for noticing the first terminal device to create the PDU session for establishing the Uu direct communication path. Correspondingly, when receiving the second switching notification message from the second terminal device, the first terminal device may create the PDU session for establishing the Uu direct communication path.

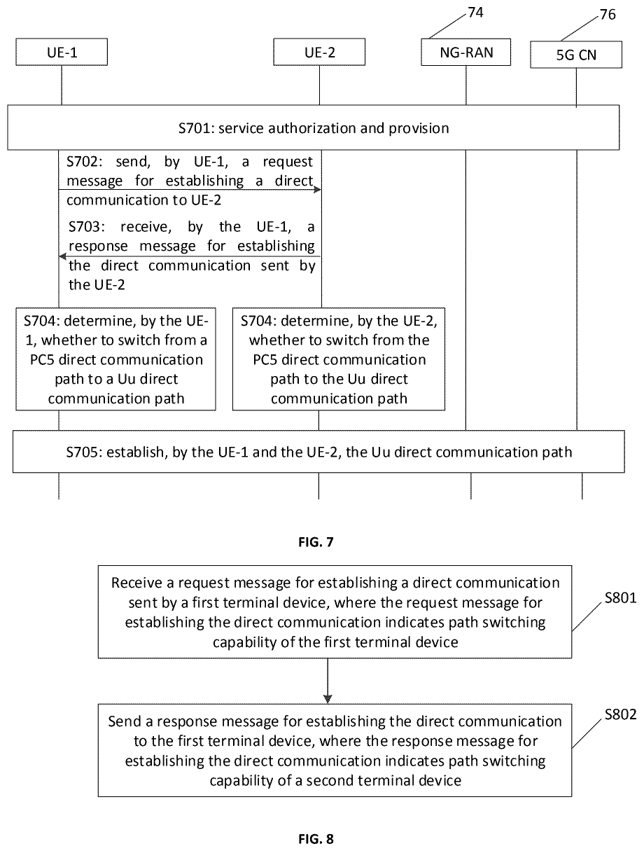

With reference to FIG. 7, where UE-1 denotes the first terminal device, and UE-2 denotes the second terminal device. Service authorization and provision need to be performed first (S701). For example, the service authorization and the provision are performed with the NG-RAN 74 and the 5G CN 76. For example, path switching capability of the UE-1 and path switching capability of the UE-2 are provided through the PCF. Or the path switching capability of the UE-1 is pre-configured in the UE-1, and the path switching capability of the UE-2 is pre-configured in the UE-2. When the UE-1 and the UE-2 need to establish the communication connection, the UE-1 may send the request message for establishing the direct communication to the UE-2 (S702), where the request message for establishing the direct communication indicates the path switching capability of the first terminal device. The UE-2 may send the response message for establishing the direct communication to the UE-1 in a case where the UE-2 receives the request message for establishing the direct communication sent by the UE-1. Correspondingly, the UE-1 may receive the response message for establishing the direct communication sent by the UE-2 (S703), so as to establish the PC5 direct communication connection between the UE-1 and the UE-2. After the PC5 direct communication path is established between the UE-1 and the UE-2, the UE-1 may perform PC5 direct communication with the UE-2.

During communication between the UE-1 and the UE-2 through the PC5 direct communication path, the UE-1 or the UE-2 may determine whether to switch from the PC5 direct communication path to the Uu direct communication path (S704). Before switching from the PC5 direct communication path to the Uu direct communication path, the UE-1 may determine whether to allow switching from the PC5 direct communication path to the Uu direct communication path according to the respective path switching capability of the UE-1 and the UE-2. In a case where it is determined to allow switching from the PC5 direct communication path to the Uu direct communication path, the Uu direct communication path may be established in the above manner (S705).

It should be noted that during communication between the first terminal device and the second terminal device through the Uu direct communication path, the first terminal device and/or the second terminal device may determine whether to switch from the Uu direct communication path to the PC5 direct communication path as required.

In the embodiment of the present disclosure, before switching from the Uu direct communication path to the PC5 direct communication path, the first terminal device may determine whether to allow switching from the Uu direct communication path to the PC5 direct communication path according to the respective path switching capability of the first terminal device and the second terminal device. A specific process is similar to the process of determining whether to allow switching from the PC5 direct communication path to the Uu direct communication path according to the respective path switching capability of the first terminal device and the second terminal device, which will not be repeated here. In a case where it is determined not to allow switching from the Uu direct communication path to the PC5 direct communication path, no path switching is performed, and a reminder may be made at the first terminal device. In a case where it is determined to allow switching from the Uu direct communication path to the PC5 direct communication path, the first terminal device and the second terminal device may establish the PC5 direct communication path. After the PC5 direct communication path is established, the first terminal device switches from the Uu direct communication path to the PC5 direct communication path, and continues communicating with the second terminal device through the PC5 direct communication path.

It should be noted that before performing S601 and S602, the first terminal device and the second terminal device need to perform network registration, so that network authentication and authorization are performed on the first terminal device and the second terminal device.

In the method for exchanging path switching capability according to the embodiments of the present disclosure, the first terminal device may send the request message for establishing the direct communication to the second terminal device, where the request message for establishing the direct communication indicates the path switching capability of the first terminal device, and the request message for establishing the direct communication is further configured to establish the PC5 direct communication path between the first terminal device and the second terminal device; and receive the response message for establishing the direct communication sent by the second terminal device, where the response message for establishing the direct communication indicates the path switching capability of the second terminal device, and the response message for establishing the direct communication is further configured to establish the PC5 direct communication path between the first terminal device and the second terminal device. Whether to allow switching from the PC5 direct communication path to the Uu direct communication path is determined according to the path switching capability of the first terminal device and the path switching capability of the second terminal device. Thus, exchanging path switching capability can be performed between two terminal devices, so that the occurrence of path switching failure can be reduced.

With reference to FIG. 8, FIG. 8 is a schematic flowchart of a method for exchanging path switching capability according to another embodiment of the present disclosure. The method for exchanging path switching capability is performed by the second terminal device. As shown in FIG. 8, the method may include, but is not limited to:

S801: the request message for establishing the direct communication sent by the first terminal device is received, where the request message for establishing the direct communication indicates path switching capability of the first terminal device.

In the embodiment of the present disclosure, the request message for establishing the direct communication is sent by the first terminal device, so as to establish the communication connection between the first terminal device and the second terminal device. Correspondingly, the second terminal device may receive the request message for establishing the direct communication sent by the first terminal device.

Optionally, the request message for establishing the direct communication is configured to establish the PC5 direct communication path between the first terminal device and the second terminal device. Or the request message for establishing the direct communication is configured to establish the Uu direct communication path between the first terminal device and the second terminal device. The PC5 direct communication path or the Uu direct communication path is configured to send data of the all ProSe or the specific ProSe.

Optionally, the path switching capability indicated by the request message for establishing the direct communication is for the all ProSe or the specific ProSe of the first terminal device. In other words, the first terminal device uses the same path switching capability for the all ProSe. Or the first terminal device uses the same path switching capability for the specific ProSe.

In the embodiment of the present disclosure, the request message for establishing the direct communication may not only be configured to establish the communication connection between the first terminal device and the second terminal device, but may also be configured to indicate the path switching capability of the first terminal device to the second terminal device.

The path switching capability of the first terminal device indicates whether the first terminal device supports the PC5 direct communication and/or the Uu direct communication. The PC5 direct communication may be interpreted as direct communication between two terminal devices via the PC5 interface. The Uu direct communication may be interpreted as communication between two terminal devices via the Uu interface, i.e., communication between the two terminal devices via the network device.

The path switching capability of the first terminal device may be provided for the first terminal device through the PCF, or may be pre-configured in the first terminal device.

It can be understood that in a case where the first terminal device supports the PC5direct communication, the path switching capability of the first terminal device may support switching to the PC5 direct communication path. In a case where the first terminal device supports the Uu direct communication, the path switching capability of the first terminal device may support switching to the Uu direct communication path. In a case where the first terminal device supports the PC5 direct communication and the Uu direct communication, the path switching capability of the first terminal device may support switching between the PC5 direct communication path and the Uu direct communication path.

S802: the response message for establishing the direct communication is sent to the first terminal device, where the response message for establishing the direct communication indicates path switching capability of the second terminal device.

In the embodiment of the present disclosure, in a case where the second terminal device receives the request message for establishing the direct communication sent by the first terminal device, the second terminal device may send the response message for establishing the direct communication to the first terminal device. Correspondingly, the first terminal device may receive the response message for establishing the direct communication sent by the second terminal device, so as to establish the communication connection between the first terminal device and the second terminal device.

Optionally, the response message for establishing the direct communication is configured to establish the PC5 direct communication path between the first terminal device and the second terminal device. Or the response message for establishing the direct communication is configured to establish the Uu direct communication path between the first terminal device and the second terminal device.

Optionally, the path switching capability indicated by the response message for establishing the direct communication is for the all ProSe or the specific ProSe of the second terminal device. In other words, the second terminal device uses the same path switching capability for the all ProSe. Or the second terminal device uses the same path switching capability for the specific ProSe.

In the embodiment of the present disclosure, the response message for establishing the direct communication may not only be configured to establish the communication connection between the first terminal device and the second terminal device, but may also be configured to indicate the path switching capability of the second terminal device to the first terminal device.

The path switching capability of the second terminal device indicates whether the second terminal device supports the PC5 direct communication and/or the Uu direct communication.

The path switching capability of the second terminal device may be provided for the second terminal device through the PCF, or may be pre-configured in the second terminal device.

It can be understood that in a case where the second terminal device supports the PC5 direct communication, the path switching capability of the first terminal device may support switching to the PC5 direct communication path. In a case where the second terminal device supports the Uu direct communication, the path switching capability of the second terminal device may support switching to the Uu direct communication path. In a case where the second terminal device supports the PC5 direct communication and the Uu direct communication, the path switching capability of the second terminal device may support switching between the PC5 direct communication path and the Uu direct communication path.

It should be noted that before performing S801 and S802, the first terminal device and the second terminal device need to perform network registration, so that network authentication and authorization are performed on the first terminal device and the second terminal device.

Since the first terminal device and the second terminal device may perform exchanging path switching capability, it is possible to determine whether to allow switching from one direct communication path to the other direct communication path according to the path switching capability of the two terminal devices. Thus, the occurrence of path switching failure can be reduced.

In the method for exchanging path switching capability according to the embodiments of the present disclosure, the second terminal device may receive the request message for establishing the direct communication sent by the first terminal device, where the request message for establishing the direct communication indicates the path switching capability of the first terminal device; and send the response message for establishing the direct communication to the first terminal device, where the response message for establishing the direct communication indicates the path switching capability of the second terminal device. Thus, exchanging path switching capability can be performed between the two terminal devices, so that the occurrence of path switching failure can be reduced.

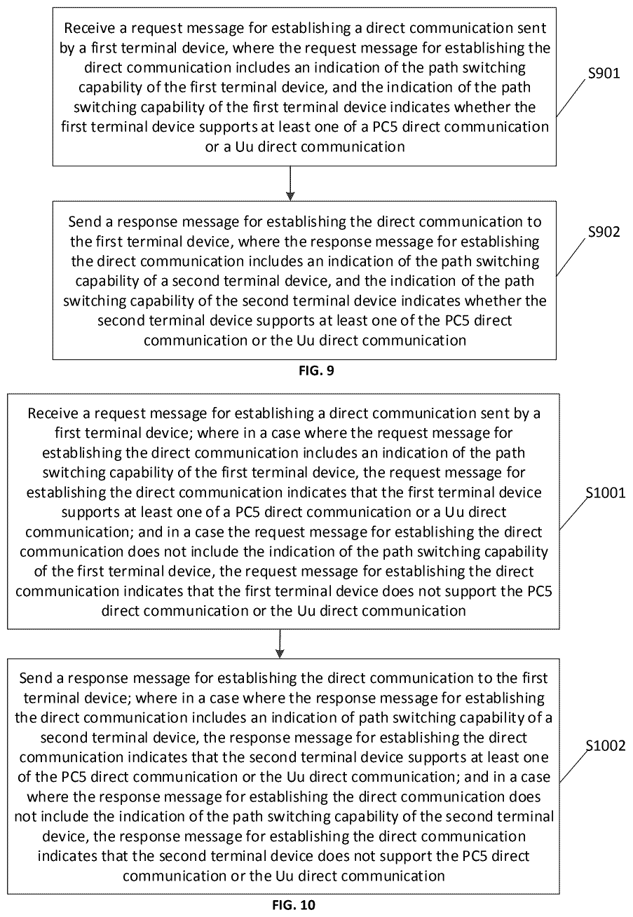

With reference to FIG. 9, FIG. 9 is a schematic flowchart of a method for exchanging path switching capability according to another embodiment of the present disclosure. The method for exchanging path switching capability may be performed by the second terminal device. As shown in FIG. 9, the method may include, but is not limited to:

S901: the request message for establishing the direct communication sent by the first terminal device is received, where the request message for establishing the direct communication includes indication of the path switching capability of the first terminal device, and the indication of the path switching capability of the first terminal device indicates whether the first terminal device supports the PC5 direct communication and/or the Uu direct communication.

In the embodiment of the present disclosure, the request message for establishing the direct communication is sent by the first terminal device, so as to establish a communication connection between the first terminal device and the second terminal device. Correspondingly, the second terminal device may receive the request message for establishing the direct communication sent by the first terminal device.

Optionally, the request message for establishing the direct communication is configured to establish the PC5 direct communication path between the first terminal device and the second terminal device. Or the request message for establishing the direct communication is configured to establish the Uu direct communication path between the first terminal device and the second terminal device.

In the embodiment of the present disclosure, the request message for establishing the direct communication may not only be configured to establish the communication connection between the first terminal device and the second terminal device, but may also be configured to indicate the path switching capability of the first terminal device to the second terminal device.

In some implementations, the indication of the path switching capability of the first terminal device may be carried in the request message for establishing the direct communication, and whether the first terminal device supports the PC5 direct communication and/or the Uu direct communication may be indicated to the second terminal device through the indication of the path switching capability.

In some implementations, the indication of the path switching capability of the first terminal device may include the switching indication of the first terminal device, and the switching indication indicates whether the first terminal device supports switching from the PC5 direct communication path to the Uu direct communication path, and/or switching from the Uu direct communication path to the PC5 direct communication path.

It can be understood that in a case where the switching indication of the first terminal device indicates that the first terminal device supports switching from the PC5 direct communication path to the Uu direct communication path, it may be determined that the path switching capability of the first terminal device supports the first terminal device in switching from the PC5 direct communication path to the Uu direct communication path. In a case where the switching indication of the first terminal device indicates that the first terminal device supports switching from the Uu direct communication path to the PC5 direct communication path, it may be determined that the path switching capability of the first terminal device supports the first terminal device in switching from the Uu direct communication path to the PC5 direct communication path. In a case where the switching indication of the first terminal device indicates that the first terminal device supports switching from the PC5 direct communication path to the Uu direct communication path and switching from the Uu direct communication path to the PC5 direct communication path, it may be determined that the path switching capability of the first terminal device supports the first terminal device in switching from the PC5 direct communication path to the Uu direct communication path and switching from the Uu direct communication to the PC5 direct communication.

It can be understood that in the instance of the present disclosure, the indication of the path switching capability of the first terminal device is added to the original request message for establishing the direct communication. For example, the indication of the path switching capability may be added to the idle information field of the request message for establishing the direct communication. For another example, the designated information field of the request message for establishing the direct communication may be multiplexed, and the indication of the path switching capability may be added to the designated information field. Thus, it is possible to indicate the path switching capability of the first terminal device to the second terminal device without adding interaction signaling between the first terminal device and the second terminal device, so that signaling resources are saved on.

Optionally, the request message for establishing the direct communication may further include at least one of: security information of the first terminal device or user information of the first terminal device.

In the embodiment of the present disclosure, after receiving the request message for establishing the direct communication, the second terminal device may determine that the first terminal device supports the PC5 direct communication and/or the Uu direct communication according to the indication of the path switching capability of the first terminal device. In other words, according to the request message for establishing the direct communication, the second terminal device may determine that the first terminal device may support the PC5 direct communication, but does not support the Uu direct communication; alternatively, the first terminal device does not support the PC5 direct communication, but supports the Uu direct communication; alternatively, the first terminal device supports the PC5 direct communication and the Uu direct communication; and alternatively, the first terminal device does not support the PC5 direct communication or the Uu direct communication.

In the embodiment of the present disclosure, after receiving the request message for establishing the direct communication, the second terminal device may determine that the first terminal device supports switching from the PC5 direct communication path to the Uu direct communication path, and/or switching from the Uu direct communication path to the PC5 direct communication path according to the switching indication included in the indication of the path switching capability of the first terminal device. In other words, according to the request message for establishing the direct communication, the second terminal device may determine that the first terminal device may support switching from the PC5 direct communication path to the Uu direct communication path, but does not support switching from the Uu direct communication path to the PC5 direct communication path; alternatively, the first terminal device does not support switching from the PC5 direct communication path to the Uu direct communication path, but supports switching from the Uu direct communication path to the PC5 direct communication path; alternatively, the first terminal device supports switching from the PC5 direct communication path to the Uu direct communication path and switching from the Uu direct communication path to the PC5 direct communication path; and alternatively, the first terminal device does not support switching from the PC5 direct communication path to the Uu direct communication path or switching from the Uu direct communication path to the PC5 direct communication path.

S902: the response message for establishing the direct communication is sent to the first terminal device, where the response message for establishing the direct communication includes indication of the path switching capability of the second terminal device, and the indication of the path switching capability of the second terminal device indicates whether the second terminal device supports the PC5 direct communication and/or the Uu direct communication.

In the embodiment of the present disclosure, in a case where the second terminal device receives the request message for establishing the direct communication sent by the first terminal device, the second terminal device may send the response message for establishing the direct communication to the first terminal device. Correspondingly, the first terminal device may receive the response message for establishing the direct communication sent by the second terminal device, so as to establish the communication connection between the first terminal device and the second terminal device.

Optionally, the response message for establishing the direct communication is configured to establish the PC5 direct communication path between the first terminal device and the second terminal device. Or the response message for establishing the direct communication is configured to establish the Uu direct communication path between the first terminal device and the second terminal device.

In the embodiment of the present disclosure, the response message for establishing the direct communication may not only be configured to establish the communication connection between the first terminal device and the second terminal device, but may also be configured to indicate the path switching capability of the second terminal device to the first terminal device.

In some implementations, the indication of the path switching capability of the second terminal device may be carried in the response message for establishing the direct communication, and whether the second terminal device supports the PC5 direct communication and/or the Uu direct communication may be indicated to the first terminal device through the indication of the path switching capability.

In some implementations, the indication of the path switching capability of the second terminal device may include the switching indication of the second terminal device, and the switching indication indicates whether the second terminal device supports switching from the PC5 direct communication path to the Uu direct communication path, and/or switching from the Uu direct communication path to the PC5 direct communication path.

It can be understood that in a case where the switching indication of the second terminal device indicates that the second terminal device supports switching from the PC5 direct communication path to the Uu direct communication path, it may be determined that the path switching capability of the second terminal device supports the second terminal device in switching from the PC5 direct communication path to the Uu direct communication path. In a case where the switching indication of the second terminal device indicates that the second terminal device supports switching from the Uu direct communication path to the PC5 direct communication path, it may be determined that the path switching capability of the second terminal device supports the second terminal device in switching from the Uu direct communication path to the PC5 direct communication path. In a case where the switching indication of the second terminal device indicates that the second terminal device supports switching from the PC5 direct communication path to the Uu direct communication path and switching from the Uu direct communication path to the PC5 direct communication path, it can be determined that the path switching capability of the second terminal device supports the second terminal device in switching from the PC5 direct communication path to the Uu direct communication path and switching from the Uu direct communication path to the PC5 direct communication path.

It can be understood that in the instance of the present disclosure, the indication of the path switching capability is added to the original response message for establishing the direct communication. For example, the indication of the path switching capability may be added to the idle information field of the response message for establishing the direct communication. For another example, the designated information field of the response message for establishing the direct communication may be multiplexed, and the indication of the path switching capability may be added to the designated information field. Thus, it is possible to indicate the path switching capability of the second terminal device to the first terminal device without adding interaction signaling between the first terminal device and the second terminal device, so that signaling resources are saved on.

Optionally, the response message for establishing the direct communication sent by the second terminal device may further include at least one of: security information of the second terminal device or user information of the first terminal device.

As a possible implementation, the indication of the path switching capability of the first terminal device and the second terminal device may each include first indication information and/or second indication information. The first indication information indicates whether the corresponding terminal device supports the PC5 direct communication; and the second indication information indicates whether the corresponding terminal device supports the Uu direct communication.

Optionally, the indication of the path switching capability includes the first indication information, and it is determined that the corresponding terminal device supports or does not support the PC5 direct communication according to the first indication information. For example, when the value of the first indication information included in the indication of the path switching capability is 1, it may be determined that the corresponding terminal device supports the PC5 direct communication. When the value of the first indication information included in the indication of the path switching capability is set to 0, it may be determined that the corresponding terminal device does not support the PC5 direct communication. In the implementation, since the indication of the path switching capability only includes the first indication information, the corresponding terminal device does not support the Uu direct communication by default.

Optionally, the indication of the path switching capability includes the second indication information, and it is determined that the corresponding terminal equipment supports or does not support the Uu direct communication according to the second indication information. For example, when the value of the second indication information included in the indication of the path switching capability is 1, it may be determined that the corresponding terminal device supports the Uu direct communication. When the value of the second indication information included in the indication of the path switching capability is 0, it may be determined that the corresponding terminal device does not support the Uu direct communication. In the implementation, since the indication of the path switching capability only includes the second indication information, the corresponding terminal device does not support the PC5 direct communication by default.

Optionally, the indication of the path switching capability includes the first indication information and the second indication information, it is determined whether the corresponding terminal device supports the PC5 direct communication according to the first indication information, and it is determined whether the corresponding terminal device supports the Uu direct communication according to the second indication information. For example, if the indication of the path switching capability is “11”, it may be determined that the corresponding terminal device supports the PC5 direct communication and the Uu direct communication. If the indication of the path switching capability is “10”, it may be determined that the corresponding terminal device supports the PC5 direct communication, but does not support the Uu direct communication. If the indication of the path switching capability is “01”, it may be determined that the corresponding terminal device does not support the PC5 direct communication, but supports the Uu direct communication. If the indication of the path switching capability is “00”, it may be determined that the corresponding terminal device does not support the PC5 direct communication or the Uu direct communication.

As another possible implementation, the indication of the path switching capability of the first terminal device and the second terminal device may include the index value, and the index value may indicate the combination condition where whether the corresponding terminal device supports the PC5 direct communication and the Uu direct communication. For example, the index value 1 may indicate that the corresponding terminal device supports the PC5 direct communication and the Uu direct communication. The index value 2 may indicate that the corresponding terminal device supports the PC5 direct communication, but does not support the Uu direct communication. The index value 3 may indicate that the corresponding terminal device does not support the PC5 direct communication, but supports the Uu direct communication. The index value 4 may indicate that the corresponding terminal device does not support the PC5 direct communication or the Uu direct communication. The second terminal device may determine the path switching capability of the first terminal device based on the index value carried in the request message for establishing the direct communication.

It should be noted that the above schematic description of the indication of the path switching capability is applicable to the indication of the path switching capability of the first terminal device and the indication of the path switching capability of the second terminal device.

It should be noted that before performing S901 and S902, the first terminal device and the second terminal device need to perform network registration, so that network authentication and authorization are performed on the first terminal device and the second terminal device.

In the method for exchanging path switching capability according to the embodiments of the present disclosure, the second terminal device may receive the request message for establishing the direct communication sent by the first terminal device, where the request message for establishing the direct communication includes the indication of the path switching capability of the first terminal device, and the indication of the path switching capability of the first terminal device indicates whether the first terminal device supports the PC5 direct communication and/or the Uu direct communication. The second terminal device may also send the response message for establishing the direct communication to the first terminal device, where the response message for establishing the direct communication includes the indication of the path switching capability of the second terminal device, and the indication of the path switching capability of the second terminal device indicates whether the second terminal device supports the PC5 direct communication and/or the Uu direct communication. Thus, exchanging path switching capability can be performed between the two terminal devices, so that the occurrence of path switching failure can be reduced.

With reference to FIG. 10, FIG. 10 is a schematic flowchart of a method for exchanging path switching capability according to another embodiment of the present disclosure. The method for exchanging path switching capability may be performed by the second terminal device. As shown in FIG. 10, the method may include, but is not limited to:

S1001: the request message for establishing the direct communication sent by the first terminal device is received. In a case where the request message for establishing the direct communication includes indication of the path switching capability of the first terminal device, the request message for establishing the direct communication indicates that the first terminal device supports the PC5 direct communication and/or the Uu direct communication. In a case where the request message for establishing the direct communication does not include the indication of the path switching capability of the first terminal device, the request message for establishing the direct communication indicates that the first terminal device does not support the PC5 direct communication or the Uu direct communication.

In the embodiment of the present disclosure, the request message for establishing the direct communication is sent by the first terminal device, so as to establish the communication connection between the first terminal device and the second terminal device. Correspondingly, the second terminal device may receive the request message for establishing the direct communication sent by the first terminal device.

Optionally, the request message for establishing the direct communication is configured to establish the PC5 direct communication path between the first terminal device and the second terminal device. Or the request message for establishing the direct communication is configured to establish the Uu direct communication path between the first terminal device and the second terminal device.

In the embodiment of the present disclosure, the request message for establishing the direct communication may not only be configured to establish the communication connection between the first terminal device and the second terminal device, but may also be configured to indicate the path switching capability of the first terminal device to the second terminal device.

In some implementations, the indication of the path switching capability of the first terminal device may be included in the request message for establishing the direct communication, so as to indicate to the second terminal device that the first terminal device supports the PC5 direct communication and/or the Uu direct communication, i.e., indicate to the second terminal device that the first terminal device supports the PC5 direct communication or the Uu direct communication, or supports the PC5 direct communication and the Uu direct communication. The indication of the path switching capability of the first terminal device may not be included in the request message for establishing the direct communication, so as to indicate to the second terminal device that the first terminal device does not support the PC5 direct communication or the Uu direct communication. Thus, it is possible to indicate the path switching capability of the first terminal device to the second terminal device without adding interaction signaling between the first terminal device and the second terminal device, so that signaling resources are saved on.

In some implementations, the indication of the path switching capability of the first terminal device may be included in the request message for establishing the direct communication, and the switching indication of the first terminal device may be included in the indication of the path switching capability of the first terminal device, so as to indicate to the second terminal device that the first terminal device supports switching from the PC5 direct communication path to the Uu direct communication path, and/or switching from the Uu direct communication path to the PC5 direct communication path. The indication of the path switching capability of the first terminal device may be included in the request message for establishing the direct communication, and the switching indication of the first terminal device may not be included in the indication of the path switching capability of the first terminal device, so as to indicate to the second terminal device that the first terminal device does not support switching from the PC5 direct communication path to the Uu direct communication path or switching from the Uu direct communication path to the PC5 direct communication path.

In some implementations, the indication of the path switching capability of the first terminal device may be included in the request message for establishing the direct communication, so as to indicate to the second terminal device that the first terminal device supports switching from the PC5 direct communication path to the Uu direct communication path, and/or switching from the Uu direct communication path to the PC5 direct communication path. The indication of the path switching capability of the first terminal device may not be included in the request message for establishing the direct communication, so as to indicate to the second terminal device that the first terminal device does not support switching from the PC5 direct communication path to the Uu direct communication path or switching from the Uu direct communication path to the PC5 direct communication path.

Optionally, the request message for establishing the direct communication may further include at least one of: security information of the first terminal device or user information of the first terminal device.

S1002: the response message for establishing the direct communication is sent to the first terminal device. In a case where the response message for establishing the direct communication includes indication of the path switching capability of the second terminal device, the response message for establishing the direct communication indicates that the second terminal device supports the PC5 direct communication and/or the Uu direct communication. In a case where the response message for establishing the direct communication does not include the indication of the path switching capability of the second terminal device, the response message for establishing the direct communication indicates that the second terminal device does not support the PC5 direct communication or the Uu direct communication.

In the embodiment of the present disclosure, in a case where the second terminal device receives the request message for establishing the direct communication sent by the first terminal device, the second terminal device may send the response message for establishing the direct communication to the first terminal device. Correspondingly, the first terminal device may receive the response message for establishing the direct communication transmitted by the second terminal device, so as to establish the communication connection between the first terminal device and the second terminal device.

Optionally, the response message for establishing the direct communication is configured to establish the PC5 direct communication path between the first terminal device and the second terminal device. Or the response message for establishing the direct communication is configured to establish the Uu direct communication path between the first terminal device and the second terminal device.

In the embodiment of the present disclosure, the response message for establishing the direct communication may not only be configured to establish the communication connection between the first terminal device and the second terminal device, but may also be configured to indicate the path switching capability of the second terminal device to the first terminal device.

In some implementations, the indication of the path switching capability of the second terminal device may be included in the response message for establishing the direct communication, so as to indicate to the first terminal device that the second terminal device supports the PC5 direct communication and/or the Uu direct communication, i.e., indicate to the first terminal device that the second terminal device supports the PC5 direct communication or the Uu direct communication, or supports the PC5 direct communication and the Uu direct communication. The indication of the path switching capability of the second terminal device may not be included in the response message for establishing the direct communication, so as to indicate to the first terminal device that the second terminal device does not support the PC5 direct communication or the Uu direct communication. Thus, it is possible to indicate the path switching capability of the second terminal device to the first terminal device without adding interaction signaling between the first terminal device and the second terminal device, so that signaling resources are saved on.

In some implementations, the indication of the path switching capability of the second terminal device may be included in the response message for establishing the direct communication, and the switching indication of the second terminal device may be included in the indication of the path switching capability of the second terminal device, so as to indicate to the first terminal device that the second terminal device supports switching from the PC5 direct communication path to the Uu direct communication path, and/or switching from the Uu direct communication path to the PC5 direct communication path. The indication of the path switching capability of the second terminal device may be included in the response message for establishing the direct communication, and the switching indication of the second terminal device may not be included in the indication of the path switching capability of the second terminal device, so as to indicate to the first terminal device that the second terminal device does not support switching from the PC5 direct communication path to the Uu direct communication path or switching from the Uu direct communication path to the PC5 direct communication path.

In some implementations, the indication of the path switching capability of the second terminal device may be included in the response message for establishing the direct communication, so as to indicate to the first terminal device that the second terminal device supports switching from the PC5 direct communication path to the Uu direct communication path, and/or switching from the Uu direct communication path to the PC5 direct communication path. The indication of the path switching capability of the second terminal device may not be included in the response message for establishing the direct communication, so as to indicate to the first terminal device that the second terminal device does not support switching from the PC5 direct communication path to the Uu direct communication path or switching from the Uu direct communication path to the PC5 direct communication path.

Optionally, the response message for establishing the direct communication sent by the second terminal device may further include at least one of: security information of the second terminal device or user information of the first terminal device.

In the embodiment of the present disclosure, after receiving the request message for establishing the direct communication, the second terminal device may determine the path switching capability of the first terminal device according to whether the indication of the path switching capability of the first terminal device is included in the request message for establishing the direct communication. In a case where the indication of the path switching capability of the first terminal device is included in the request message for establishing the direct communication, it may be determined that the path switching capability of the first terminal device is that the first terminal device supports the PC5 direct communication; alternatively, the first terminal device supports the Uu direct communication; and alternatively, the first terminal device supports the PC5 direct communication and the Uu direct communication. In a case where the indication of the path switching capability of the first terminal device is not included in the request message for establishing the direct communication, it may be determined that the path switching capability of the first terminal device is that the first terminal device does not support the PC5 direct communication or the Uu direct communication.

As a possible implementation, in a case where the indication of the path switching capability includes third indication information, the indication of the path switching capability of the first terminal device and the second terminal device may indicate that the corresponding terminal device supports the PC5 direct communication. In a case where the indication of the path switching capability does not include the third indication information, the indication of the path switching capability of the first terminal device and the second terminal device may indicate that the corresponding terminal device does not support the PC5 direct communication.

As a possible implementation, in a case where the indication of the path switching capability includes fourth indication information, the indication of the path switching capability of the first terminal device and the second terminal device may indicate that the corresponding terminal device supports the Uu direct communication. In a case where the indication of the path switching capability does not include the fourth indication information, the indication of the path switching capability of the first terminal device and the second terminal device may indicate that the corresponding terminal device does not support the Uu direct communication.

Optionally, in a case where the indication of the path switching capability includes the third indication information, but does not include the fourth indication information, it may be determined that the corresponding terminal device supports the PC5 direct communication, but does not support the Uu direct communication. Optionally, in a case where the indication of the path switching capability does not include the third indication information, but includes the fourth indication information, it may be determined that the corresponding terminal device does not support the PC5 direct communication, but supports the Uu direct communication. Optionally, in a case where the indication of the path switching capability includes the third indication information and the fourth indication information, it may be determined that the corresponding terminal device supports the PC5 direct communication and the Uu direct communication. Optionally, in a case where the indication of the path switching capability does not include the third indication information or the fourth indication information, it may be determined that the corresponding terminal device does not support the PC5 direct communication or the Uu direct communication.

It should be noted that the above schematic description of the indication of the path switching capability is applicable to the indication of the path switching capability of the first terminal device and the indication of the path switching capability of the second terminal device.

It should be noted that before performing S1001 and S1002, the first terminal device and the second terminal device need to perform network registration, so that network authentication and authorization are performed on the first terminal device and the second terminal device.

In the method for exchanging path switching capability according to the embodiments of the present disclosure, the second terminal device may receive the request message for establishing the direct communication sent by the first terminal device. In a case where the request message for establishing the direct communication includes the indication of the path switching capability of the first terminal device, the request message for establishing the direct communication indicates that the first terminal device supports the PC5 direct communication and/or the Uu direct communication. In a case where the request message for establishing the direct communication does not include the indication of the path switching capability of the first terminal device, the request message for establishing the direct communication indicates that the first terminal device does not support the PC5 direct communication or the Uu direct communication. The second terminal device may also send the response message for establishing the direct communication to the first terminal device. In a case where the response message for establishing the direct communication includes the indication of the path switching capability of the second terminal device, the response message for establishing the direct communication indicates that the second terminal device supports the PC5 direct communication and/or the Uu direct communication. In a case where the response message for establishing the direct communication does not include the indication of the path switching capability of the second terminal device, the response message for establishing the direct communication indicates that the second terminal device does not support the PC5 direct communication or the Uu direct communication. Thus, exchanging path switching capability can be performed between two terminal devices, so that the occurrence of path switching failure can be reduced.

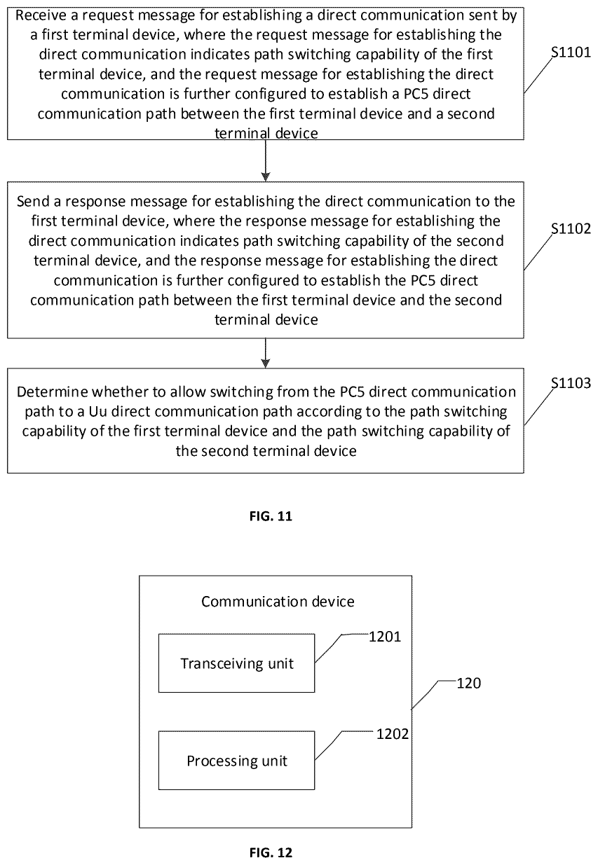

With reference to FIG. 11, FIG. 11 is a schematic flowchart of a method for exchanging path switching capability according to another embodiment of the present disclosure. The method for exchanging path switching capability may be performed by the second terminal device. As shown in FIG. 11, the method may include, but is not limited to:

S1101: the request message for establishing the direct communication sent by the first terminal device is received, where the request message for establishing the direct communication indicates path switching capability of the first terminal device, and the request message for establishing the direct communication is further configured to establish the PC5 direct communication path between the first terminal device and the second terminal device.

S1102: the response message for establishing the direct communication is sent to the first terminal device, where the response message for establishing the direct communication indicates path switching capability of the second terminal device, and the response message for establishing the direct communication is further configured to establish the PC5 direct communication path between the first terminal device and the second terminal device.

Reference can be made to the description of relevant contents such as S801-S802, S901-S902, or S1001-S1002 in the above embodiment for the specific description of S1101-S1102, which will not be repeated here.

S1103: determining whether to allow switching from the PC5 direct communication path to the Uu direct communication path, according to the path switching capability of the first terminal device and the path switching capability of the second terminal device.

In the embodiment of the present disclosure, the request message for establishing the direct communication and the response message for establishing the direct communication are configured to establish the PC5 direct communication path between the first terminal device and the second terminal device. After receiving the response message for establishing the direct communication, the first terminal device may start to establish the PC5 direct communication path with the second terminal device. After the PC5 direct communication path is established between the first terminal device and the second terminal device, the PC5 direct communication may be performed between the first terminal device and the second terminal device.

In some implementations, during communication between the first terminal device and the second terminal device through the PC5 direct communication path, the second terminal device may measure a signal quality of the PC5 direct communication path in real time. When it is measured that the signal quality of the PC5 direct communication path does not satisfy a signal quality condition, in order to ensure a communication quality between the first terminal device and the second terminal device, the second terminal device may attempt to switch from the PC5 direct communication path to the Uu direct communication path.

In some implementations, the second terminal device may actively interrupt the PC5 direct communication path with the first terminal device. In this case, the second terminal device also needs to switch from the PC5 direct communication path to the Uu direct communication path.

In the embodiment of the present disclosure, before switching from the PC5 direct communication path to the Uu direct communication path, the second terminal device may determine whether to allow switching from the PC5 direct communication path to the Uu direct communication path according to the respective path switching capability of the first terminal device and the second terminal device.

In some implementations, during communication between the first terminal device and the second terminal device through the PC5 direct communication path, in a case where the first terminal device supports the Uu direct communication and the second terminal device supports the Uu direct communication, it is determined to allow switching from the PC5 direct communication path to the Uu direct communication path. In a case where the first terminal device does not support the Uu direct communication, or the second terminal device does not support the Uu direct communication, it is determined not to allow switching from the PC5 direct communication path to the Uu direct communication path.

In some implementations, during communication between the first terminal device and the second terminal device through the PC5 direct communication path, in a case where the first terminal device supports the Uu direct communication, the second terminal device supports the Uu direct communication, the first terminal device supports switching from the PC5 direct communication path to the Uu direct communication path, and the second terminal device supports switching from the PC5 direct communication path to the Uu direct communication path, it is determined to allow switching from the PC5 direct communication path to the Uu direct communication path. In a case where the first terminal device does not support the Uu direct communication, alternatively, the second terminal device does not support the Uu direct communication, alternatively, the first terminal device does not support switching from the PC5 direct communication path to the Uu direct communication path, and alternatively, the second terminal device does not support switching from the PC5 direct communication path to the Uu direct communication path, it is determined not to allow switching from the PC5 direct communication path to the Uu direct communication path.

In some implementations, in a case where it is determined not to allow switching from the PC5 direct communication path to the Uu direct communication path, no path switching is performed, and a reminder may be made at the second terminal device. In a case where it is determined to allow switching from the PC5 direct communication path to the Uu direct communication path, the second terminal device may perform the following steps: creating a PDU session for establishing the Uu direct communication path; and sending the second switching notification message to the first terminal device for noticing the first terminal device to create the PDU session for establishing the Uu direct communication path.

It can be understood that the Uu direct communication path indicates that the first terminal device communicates with the second terminal device through the network device. The first terminal device and the second terminal device need to establish part of the Uu direct communication path with the network device separately. The network device connects a Uu direct communication path section corresponding to the first terminal device to a Uu direct communication path section corresponding to the second terminal device, so that the Uu direct communication path between the first terminal device and the second terminal device is formed.

In the embodiment of the present disclosure, the second terminal device may create the PDU session, perform a PDU session process with the network device, and establish the Uu direct communication path section between the second terminal device and the network device in the PDU session process. The Uu direct communication path section is a communication path established between the second terminal device and a user plane function (UPF) of the core network through a radio access network (RAN), and may be marked as a UE2-RAN-UPF.

In the embodiment of the present disclosure, in a case where it is determined to allow switching from the PC5 direct communication path to the Uu direct communication path, the second terminal device may also need to send the second switching notification message to the first terminal device, where the second switching notification message instructs the first terminal device to create the PDU session with the network device for establishing the Uu direct communication path. Correspondingly, the first terminal device may create the PDU session according to the second switching notification message, perform the PDU session process with the network device, and establish the Uu direct communication path section between the first terminal device and the network device in the PDU session process. The Uu direct communication path section is a communication path established between the first terminal device and a UPF (UPF2) of the core network through the RAN, and may be marked as a UE1-RAN-UPF (UPF2).

After the first terminal device and the second terminal device establish the Uu direct communication path, the Uu direct communication path between the first terminal device and the second terminal device, i.e., UE1-RAN-UPF (URF2)-RAN-UE2 may be formed by connecting the UE1-RAN-UPF and the UE2-RAN-UPF.

After the Uu direct communication path is established, the second terminal device switches from the PC5 direct communication path to the Uu direct communication path, and continues communicating with the first terminal device through the Uu direct communication path.

It can be understood that after switching from the PC5 direct communication path to the Uu direct communication path between the first terminal device and the second terminal device, resources may be saved on by releasing the PC5 direct communication path.

In some implementations, in a case where it is determined to allow switching from the PC5 direct communication path to the Uu direct communication path, the first terminal device may perform the following steps: creating the PDU session for establishing the Uu direct communication path; and sending the first switching notification message to the second terminal device for noticing the second terminal device to create the PDU session for establishing the Uu direct communication path. Correspondingly, when receiving the first switching notification message from the first terminal device, the second terminal device may create the PDU session for establishing the Uu direct communication path.

It should be noted that during communication between the first terminal device and the second terminal device through the Uu direct communication path, the first terminal device and/or the second terminal device may determine whether to switch from the Uu direct communication path to the PC5 direct communication path as required.

In the embodiment of the present disclosure, before switching from the Uu direct communication path to the PC5 direct communication path, the second terminal device may determine whether to allow switching from the Uu direct communication path to the PC5 direct communication path according to the respective path switching capability of the first terminal device and the second terminal device. A specific process is similar to the process of determining whether to allow switching from the PC5 direct communication path to the Uu direct communication path according to the respective path switching capability of the first terminal device and the second terminal device, which will not be repeated here. In a case where it is determined not to allow switching from the Uu direct communication path to the PC5 direct communication path, no path switching is performed, and a reminder may be made at the second terminal device. In a case where it is determined to allow switching from the Uu direct communication path to the PC5 direct communication path, the first terminal device and the second terminal device may establish the PC5 direct communication path. After the PC5 direct communication path is established, the second terminal device switches from the Uu direct communication path to the PC5 direct communication path, and continues communicating with the first terminal device through the PC5 direct communication path.

It should be noted that before performing S1101 and S1102, the first terminal device and the second terminal device need to perform network registration, so that network authentication and authorization are performed on the first terminal device and the second terminal device.

In the method for exchanging path switching capability according to the embodiments of the present disclosure, the second terminal device may receive the request message for establishing the direct communication sent by the first terminal device, where the request message for establishing the direct communication indicates the path switching capability of the first terminal device, and the request message for establishing the direct communication is further configured to establish the PC5 direct communication path between the first terminal device and the second terminal device; and send the response message for establishing the direct communication to the first terminal device, where the response message for establishing the direct communication indicates the path switching capability of the second terminal device, and the response message for establishing the direct communication is further configured to establish the PC5 direct communication path between the first terminal device and the second terminal device. Whether to allow switching from the PC5 direct communication path to the Uu direct communication path is determined according to the path switching capability of the first terminal device and the path switching capability of the second terminal device. Thus, exchanging path switching capability can be performed between two terminal devices, so that the occurrence of path switching failure can be reduced.

It should be noted that “carry”, “comprise”, and “include” have the same meaning in the present disclosure. The terms “comprise” and “include” in the present disclosure indicate the open-ended definition. In other words, in addition to contents indicated in the present disclosure, contents that are not indicated in the present disclosure but may appear in the future may be included.

In the above embodiments of the present disclosure, the method according to the embodiments of the present disclosure is described from the perspectives of the first terminal device and the second terminal device separately. In order to implement all the functions in the method according to the embodiments of the present disclosure, the terminal device may include a hardware structure and a software module, and implement all the above functions in a form of the hardware structure, the software module, or the hardware structure plus the software module. One of all the above functions may be executed in a form of the hardware structure, the software module, or the hardware structure plus the software module.

With reference to FIG. 12, FIG. 12 is a schematic structural diagram of a communication device 120 according to an embodiment of the present disclosure. The communication device 120 shown in FIG. 12 may include a transceiving unit 1201 and a processing unit 1202. The transceiving unit 1201 may include a sending unit and/or a reception unit; where the sending unit is configured to implement a function of sending, the reception unit is configured to implement a function of reception, and the transceiving unit 1201 may implement the function of sending and/or the function of reception.

The communication device 120 may be a terminal device (such as the first terminal device or the second terminal device in the foregoing method embodiment), a device in the terminal device, or a device that may be used in conjunction with the terminal device.

In a case where the communication device 120 is the terminal device (such as the first terminal device in the foregoing method embodiment):

The transceiving unit 1201 is configured to send a request message for establishing the direct communication to a second terminal device, where the request message for establishing the direct communication indicates path switching capability of the first terminal device; and receive a response message for establishing the direct communication sent by the second terminal device, where the response message for establishing the direct communication indicates path switching capability of the second terminal device.

Optionally, the request message for establishing the direct communication includes indication of the path switching capability of the first terminal device, and the indication of the path switching capability of the first terminal device indicates whether the first terminal device supports the PC5 direct communication and/or the Uu direct communication. The response message for establishing the direct communication includes indication of the path switching capability of the second terminal device, and the indication of the path switching capability of the second terminal device indicates whether the second terminal device supports the PC5 direct communication and/or the Uu direct communication.

Optionally, the indication of the path switching capability includes first indication information and/or second indication information; where the first indication information indicates whether the corresponding terminal device supports the PC5 direct communication; and the second indication information indicates whether the corresponding terminal device supports the Uu direct communication.

Optionally, in a case where the request message for establishing the direct communication includes the indication of the path switching capability of the first terminal device, the request message for establishing the direct communication indicates that the first terminal device supports the PC5 direct communication and/or the Uu direct communication. In a case where the request message for establishing the direct communication does not include the indication of the path switching capability of the first terminal device, the request message for establishing the direct communication indicates that the first terminal device does not support the PC5 direct communication or the Uu direct communication.

Optionally, in a case where the response message for establishing the direct communication includes the indication of the path switching capability of the second terminal device, the response message for establishing the direct communication indicates that the second terminal device supports the PC5 direct communication and/or the Uu direct communication. In a case where the response message for establishing the direct communication does not include the indication of the path switching capability of the second terminal device, the response message for establishing the direct communication indicates that the second terminal device does not support the PC5 direct communication or the Uu direct communication.

Optionally, in a case where the indication of the path switching capability includes third indication information, the indication of the path switching capability indicates that the corresponding terminal device supports the PC5 direct communication. In a case where the indication of the path switching capability does not include the third indication information, the indication of the path switching capability indicates that the corresponding terminal device does not support the PC5 direct communication.

Optionally, in a case where the indication of the path switching capability includes fourth indication information, the indication of the path switching capability indicates that the corresponding terminal device supports the Uu direct communication. In a case where the indication of the path switching capability does not include the fourth indication information, the indication of the path switching capability indicates that the corresponding terminal device does not support the Uu direct communication.

Optionally, the request message for establishing the direct communication and the response message for establishing the direct communication are configured to establish a PC5 direct communication path between the first terminal device and the second terminal device.

Optionally, the processing unit 1202 is configured to determine whether to allow switching from the PC5 direct communication path to a Uu direct communication path, according to the path switching capability of the first terminal device and the path switching capability of the second terminal device.

Optionally, in a case where the first terminal device supports the Uu direct communication and the second terminal device supports the Uu direct communication, the processing unit 1202 is further configured to determine to allow switching from the PC5 direct communication path to the Uu direct communication path. In a case where the first terminal device does not support the Uu direct communication, or the second terminal device does not support the Uu direct communication, the processing unit 1202 is further configured to determine not to allow switching from the PC5 direct communication path to the Uu direct communication path.

In a case where the communication device 120 is the terminal device (such as the second terminal device in the foregoing method embodiment):

The transceiving unit 1201 is configured to receive the request message for establishing the direct communication sent by the first terminal device, where the request message for establishing the direct communication indicates path switching capability of the first terminal device; and send the response message for establishing the direct communication to the first terminal device, where the response message for establishing the direct communication indicates path switching capability of the second terminal device.

Optionally, the request message for establishing the direct communication includes indication of the path switching capability of the first terminal device, and the indication of the path switching capability of the first terminal device indicates whether the first terminal device supports the PC5 direct communication and/or the Uu direct communication. The response message for establishing the direct communication includes indication of the path switching capability of the second terminal device, and the indication of the path switching capability of the second terminal device indicates whether the second terminal device supports the PC5 direct communication and/or the Uu direct communication.

Optionally, the indication of the path switching capability includes first indication information and/or second indication information; where the first indication information indicates whether the corresponding terminal device supports the PC5 direct communication; and the second indication information indicates whether the corresponding terminal device supports the Uu direct communication.

Optionally, in a case where the request message for establishing the direct communication includes the indication of the path switching capability of the first terminal device, the request message for establishing the direct communication indicates that the first terminal device supports the PC5 direct communication and/or the Uu direct communication. In a case where the request message for establishing the direct communication does not include the indication of the path switching capability of the first terminal device, the request message for establishing the direct communication indicates that the first terminal device does not support the PC5 direct communication or the Uu direct communication.

Optionally, in a case where the response message for establishing the direct communication includes the indication of the path switching capability of the second terminal device, the response message for establishing the direct communication indicates that the second terminal device supports the PC5 direct communication and/or the Uu direct communication. In a case where the response message for establishing the direct communication does not include the indication of the path switching capability of the second terminal device, the response message for establishing the direct communication indicates that the second terminal device does not support the PC5 direct communication or the Uu direct communication.

Optionally, in a case where the indication of the path switching capability includes third indication information, the indication of the path switching capability indicates that the corresponding terminal device supports the PC5 direct communication. In a case where the indication of the path switching capability does not include the third indication information, the indication of the path switching capability indicates that the corresponding terminal device does not support the PC5 direct communication.

Optionally, in a case where the indication of the path switching capability includes fourth indication information, the indication of the path switching capability indicates that the corresponding terminal device supports the Uu direct communication. In a case where the indication of the path switching capability does not include the fourth indication information, the indication of the path switching capability indicates that the corresponding terminal device does not support the Uu direct communication.

Optionally, the request message for establishing the direct communication and the response message for establishing the direct communication are configured to establish the PC5 direct communication path between the first terminal device and the second terminal device.

Optionally, the processing unit 1202 is configured to determine whether to allow switching from the PC5 direct communication path to a Uu direct communication path, according to the path switching capability of the first terminal device and the path switching capability of the second terminal device.

Optionally, in a case where the first terminal device supports the Uu direct communication and the second terminal device supports the Uu direct communication, the processing unit 1202 is further configured to determine to allow switching from the PC5 direct communication path to the Uu direct communication path. In a case where the first terminal device does not support the Uu direct communication, or the second terminal device does not support the Uu direct communication, the processing unit 1202 is further configured to determine not to allow switching from the PC5 direct communication path to the Uu direct communication path.

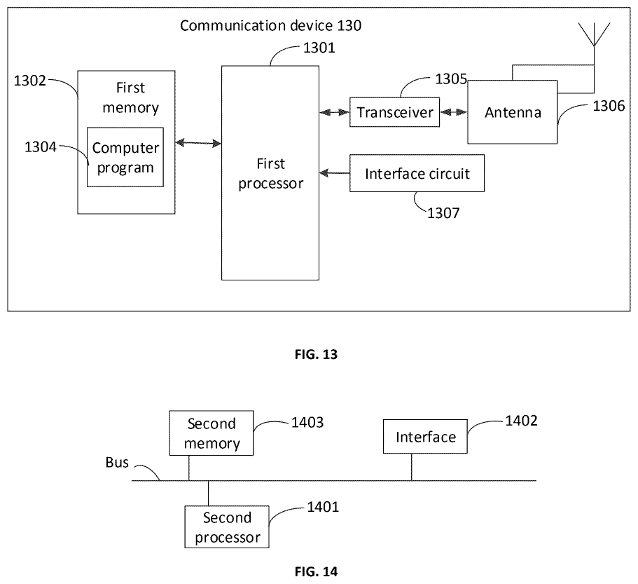

With reference to FIG. 13, FIG. 13 is a schematic structural diagram of a communication device 130 according to another embodiment of the present disclosure. The communication device 130 may be a terminal device (such as the first terminal device or the second terminal device in the foregoing method embodiment), or a chip, chip system, or processor that supports the terminal device in implementing the above method. The device may be configured to implement the method described in the above method embodiment, and reference can be made to the description in the above method embodiment for details.

The communication device 130 may include one or more first processors 1301. The first processor 1301 may be a general-purpose processor, a special-purpose processor, etc. For example, the processor may be a baseband processor or a central processing unit. The baseband processor may be configured to process communication protocols and communication data. The central processing unit may be configured to control the communication device (such as a base station, a baseband chip, the terminal device, a terminal device chip, the DU, and the CU), perform a computer program, and process data of the computer program.

Optionally, the communication device 130 may further include one or more first memories 1302, where the first memory 1302 stores a computer program 1304, the first processor 1301 causes the communication device 130 to perform the method described in the above method embodiment by executing the computer program 1304. Optionally, the first memory 1302 may also store data. The communication device 130 and the first memory 1302 may be arranged separately or integrated together.

Optionally, the communication device 130 may further include a transceiver 1305 and an antenna 1306. The transceiver 1305 may be referred to as a transceiving unit, a transceiving machine, a transceiving circuit, etc., and is configured to implement a function of transceiving. The transceiver 1305 may include a receiver and a transmitter; where the receiver may be referred to as a reception machine, a reception circuit, etc., and is configured to implement a function of reception; and the transmitter may be referred to as a transmission machine, a transmission circuit, etc., and is configured to implement a function of transmission.

Optionally, the communication device 130 may further include one or more interface circuits 1307. The interface circuit 1307 is configured to receive code instructions, and send the code instructions to the first processor 1301. The first processor 1301 causes the communication device 130 to perform the method described in the above method embodiment by running the code instructions.

In a case where the communication device 130 is the terminal device (such as the first terminal device in the foregoing method embodiment): the transceiver 1305 is configured to perform S301 and S302 in FIG. 3; S401 and S402 in FIG. 4; S501 and S502 in FIG. 5; and S601 and S602 in FIG. 6.

The first processor 1301 is configured to perform S603 in FIG. 6.

In a case where the communication device 130 is the terminal device (such as the second terminal device in the foregoing embodiment): the transceiver 1305 is configured to perform S801 and S802 in FIG. 8; S901 and S902 in FIG. 9; S1001 and S1002 in FIG. 10; and S1101 and S1102 in FIG. 11.

The first processor 1301 is configured to perform S1103 in FIG. 11.

In an implementation, the first processor 1301 may include a transceiver configured to implement functions of reception and sending. For example, the transceiver may be a transceiving circuit, an interface, or an interface circuit. The transceiving circuit, interface, or interface circuit configured to implement the functions of reception and sending may be separated or integrated together. The above transceiving circuit, interface, or interface circuit may be configured to read and write codes/data. Alternatively, the above transceiving circuit, interface, or interface circuit may be configured to transmit or transfer a signal.

In an implementation, the first processor 1301 may store a computer program, where the computer program, when run on the first processor 1301, may cause the communication device 130 to perform the method described in the above method embodiment. The computer program may be firmed in the first processor 1301. In this case, first the processor 1301 may be implemented by hardware.

In an implementation, the communication device 130 may include a circuit, where the circuit may implement the function of sending, reception, or communication in the foregoing method embodiment. The first processor 1301 and the transceiver 1305 described in the present disclosure may be implemented on an integrated circuit (IC), an analog IC, a radio frequency integrated circuit (RFIC), a mixed-signal IC, an application specific integrated circuit (ASIC), a printed circuit board (PCB), an electronic device, etc. The first processor 1301 and the transceiver 1305 or may be fabricated through various IC process technologies, such as a complementary metal oxide semiconductor (CMOS), an nmetal-oxide-semiconductor (NMOS), a positive channel metal oxide semiconductor (PMOS), a bipolar junction transistor (BJT), a bipolar CMOS (BiCMOS), silicon germanium (SiGe), and gallium arsenide (GaAs).

The communication device described in the above embodiment may be the terminal device (such as the first terminal device or the second terminal device in the foregoing method embodiment), but which is not intended to limit the scope of the communication device described in the present disclosure. The structure of the communication device may not be limited by FIG. 13. The communication device may be a stand-alone device or a part of a large device. For example, the communication device may be:
(1) an independent integrated circuit (IC), a chip, a chip system, or a chip sub-system;
(2) a set having one or more ICs, which may optionally include a storage component configured to store data and computer programs;
(3) an ASIC, such as a modem;
(4) a module, which may be embedded in other devices;
(5) a receiver, a terminal device, a smart terminal device, a cellular phone, a radio device, a handset, a mobile unit, a vehicle-mounted device, a network device, a cloud device, an artificial intelligence device, etc. ; and
(6) a different device, etc.

Reference can be made to the schematic structural diagram of a chip shown in FIG. 14 for the case where the communication device may be the chip or chip system. The chip shown in FIG. 14 includes a second processor 1401 and an interface 1402. One or more second processors 1401 may be provided, and a plurality of interfaces 1402 may be provided.

In a case where the chip is configured to implement the functions of the terminal device (such as the first terminal device in the above method embodiment) in the embodiment of the present disclosure:

The interface 1402 is configured to send the request message for establishing the direct communication to the second terminal device, where the request message for establishing the direct communication indicates path switching capability of the first terminal device; and receive the response message for establishing the direct communication sent by the second terminal device, where the response message for establishing the direct communication indicates path switching capability of the second terminal device.

Optionally, the request message for establishing the direct communication includes indication of the path switching capability of the first terminal device, and the indication of the path switching capability of the first terminal device indicates whether the first terminal device supports the PC5 direct communication and/or the Uu direct communication. The response message for establishing the direct communication includes indication of the path switching capability of the second terminal device, and the indication of the path switching capability of the second terminal device indicates whether the second terminal device supports the PC5 direct communication and/or the Uu direct communication.

Optionally, the indication of the path switching capability includes first indication information and/or second indication information; where the first indication information indicates whether the corresponding terminal device supports the PC5 direct communication; and the second indication information indicates whether the corresponding terminal device supports the Uu direct communication.

Optionally, in a case where the request message for establishing the direct communication includes the indication of the path switching capability of the first terminal device, the request message for establishing the direct communication indicates that the first terminal device supports the PC5 direct communication and/or the Uu direct communication. In a case where the request message for establishing the direct communication does not include the indication of the path switching capability of the first terminal device, the request message for establishing the direct communication indicates that the first terminal device does not support the PC5 direct communication or the Uu direct communication.

Optionally, in a case where the response message for establishing the direct communication includes the indication of the path switching capability of the second terminal device, the response message for establishing the direct communication indicates that the second terminal device supports the PC5 direct communication and/or the Uu direct communication. In a case where the response message for establishing the direct communication does not include the indication of the path switching capability of the second terminal device, the response message for establishing the direct communication indicates that the second terminal device does not support the PC5 direct communication or the Uu direct communication.

Optionally, in a case where the indication of the path switching capability includes third indication information, the indication of the path switching capability indicates that the corresponding terminal device supports the PC5 direct communication. In a case where the indication of the path switching capability does not include the third indication information, the indication of the path switching capability indicates that the corresponding terminal device does not support the PC5 direct communication.

Optionally, in a case where the indication of the path switching capability includes fourth indication information, the indication of the path switching capability indicates that the corresponding terminal device supports the Uu direct communication. In a case where the indication of the path switching capability does not include the fourth indication information, the indication of the path switching capability indicates that the corresponding terminal device does not support the Uu direct communication.

Optionally, the request message for establishing the direct communication and the response message for establishing the direct communication are configured to establish the PC5 direct communication path between the first terminal device and the second terminal device.

Optionally, the second processor 1401 is configured to determine whether to allow switching from the PC5 direct communication path to the Uu direct communication path, according to the path switching capability of the first terminal device and the path switching capability of the second terminal device.

Optionally, in a case where the first terminal device supports the Uu direct communication and the second terminal device supports the Uu direct communication, the second processor 1401 is further configured to determine to allow switching from the PC5 direct communication path to the Uu direct communication path. In a case where the first terminal device does not support the Uu direct communication, or the second terminal device does not support the Uu direct communication, the processor 1401 is further configured to determine not to allow switching from the PC5 direct communication path to the Uu direct communication path.

In a case where the chip is configured to implement the functions of the terminal device (such as the second terminal device in the above method embodiment) in the embodiment of the present disclosure:

The interface 1402 is configured to receive the request message for establishing the direct communication sent by the first terminal device, where the request message for establishing the direct communication indicates path switching capability of the first terminal device; and send the response message for establishing the direct communication to the first terminal device, where the response message for establishing the direct communication indicates path switching capability of the second terminal device.

Optionally, the request message for establishing the direct communication includes indication of the path switching capability of the first terminal device, and the indication of the path switching capability of the first terminal device indicates whether the first terminal device supports the PC5 direct communication and/or the Uu direct communication. The response message for establishing the direct communication includes indication of the path switching capability of the second terminal device, and the indication of the path switching capability of the second terminal device indicates whether the second terminal device supports the PC5 direct communication and/or the Uu direct communication.

Optionally, the indication of the path switching capability includes first indication information and/or second indication information; where the first indication information indicates whether the corresponding terminal device supports the PC5 direct communication; and the second indication information indicates whether the corresponding terminal device supports the Uu direct communication.

Optionally, in a case where the request message for establishing the direct communication includes the indication of the path switching capability of the first terminal device, the request message for establishing the direct communication indicates that the first terminal device supports the PC5 direct communication and/or the Uu direct communication. In a case where the request message for establishing the direct communication does not include the indication of the path switching capability of the first terminal device, the request message for establishing the direct communication indicates that the first terminal device does not support the PC5 direct communication or the Uu direct communication.

Optionally, in a case where the response message for establishing the direct communication includes the indication of the path switching capability of the second terminal device, the response message for establishing the direct communication indicates that the second terminal device supports the PC5 direct communication and/or the Uu direct communication. In a case where the response message for establishing the direct communication does not include the indication of the path switching capability of the second terminal device, the response message for establishing the direct communication indicates that the second terminal device does not support the PC5 direct communication or the Uu direct communication.

Optionally, in a case where the indication of the path switching capability includes third indication information, the indication of the path switching capability indicates that the corresponding terminal device supports the PC5 direct communication. In a case where the indication of the path switching capability does not include the third indication information, the indication of the path switching capability indicates that the corresponding terminal device does not support the PC5 direct communication.

Optionally, in a case where the indication of the path switching capability includes fourth indication information, the indication of the path switching capability indicates that the corresponding terminal device supports the Uu direct communication. In a case where the indication of the path switching capability does not include the fourth indication information, the indication of the path switching capability indicates that the corresponding terminal device does not support the Uu direct communication.

Optionally, the request message for establishing the direct communication and the response message for establishing the direct communication are configured to establish the PC5 direct communication path between the first terminal device and the second terminal device.

Optionally, the second processor 1401 is configured to determine whether to allow switching from the PC5 direct communication path to the Uu direct communication path, according to the path switching capability of the first terminal device and the path switching capability of the second terminal device.

Optionally, in a case where the first terminal device supports the Uu direct communication and the second terminal device supports the Uu direct communication, the second processor 1401 is further configured to determine to allow switching from the PC5 direct communication path to the Uu direct communication path. In a case where the first terminal device does not support the Uu direct communication, or the second terminal device does not support the Uu direct communication, the processor 1401 is further configured to determine not to allow switching from the PC5 direct communication path to the Uu direct communication path.

Optionally, the chip further includes a second memory 1403, where the second memory 1403 is configured to store the necessary computer program and data.

Those skilled in the art can also appreciate that various illustrative logical blocks and steps set forth in the embodiments of the present disclosure can be implemented through electronic hardware, computer software, or their combinations. Whether such functions are implemented through the hardware or the software depends on the particular application and overall system design requirements. Those skilled in the art can implement the functions through various methods for each particular application, but such an implementation should not be interpreted as falling beyond the scope of protection of the embodiments of the present disclosure.

A communication system is further provided in the embodiments of the present disclosure. The system includes the communication device serving as the terminal device (such as the first terminal device in the foregoing method embodiment) and the communication device serving as the terminal device (such as the second terminal device in the foregoing method embodiment) in the foregoing embodiment in FIG. 13. Alternatively, the system includes the communication device serving as the terminal device (such as the first terminal device in the foregoing method embodiment) and the communication device serving as the terminal device (such as the second terminal device in the foregoing method embodiment) in the foregoing embodiment in FIG. 14.

The present disclosure further provides a readable storage medium. The readable storage medium stores instructions, where the instructions, when executed by a computer, implement the functions in any method embodiment above.

The present disclosure further provides a computer program product. The computer program product, when executed by a computer, implements the functions in any method embodiment above.

As used herein, the term processor may refer to one processor that performs the defined functions or a plurality of processors that collectively perform defined functions, so that the execution of the individual defined functions may be divided amongst such processors.

In the above embodiment, some or all of the functions may be implemented through software, hardware, firmware, or their any combinations. When implemented through the software, some or all of the functions may be implemented in a form of the computer program product. The computer program product includes one or more computer programs. Some or all of the computer programs, when loaded and executed on the computer, generate the flows or functions according to the embodiments of the present disclosure. The computer can be a general-purpose computer, a special-purpose computer, a computer network, or another programmable device. The computer program can be stored in a computer-readable storage medium, or transmitted from one computer-readable storage medium to another computer-readable storage medium, for example, from one website, computer, server, or data center to another website, computer, server, or data center through a wired means (for example, a coaxial cable, an optical fiber, and a digital subscriber line (DSL)), or a wireless means (for example, infrared, radio waves, and microwaves). The computer-readable storage medium can be any available medium that a computer can access, or an integrated server, data center, etc. encompassing one or more available media. The available medium can be a magnetic medium (for example, a floppy disk, a hard disk, and a tape), an optical medium (for example, a digital video disk (DVD)), a semiconductor medium (for example, a solid state disk (SSD)), etc.

Those of ordinary skill in the art can understand that various numerical numbers such as first and second involved in the present disclosure are merely for convenience of description, instead of limiting the scope of the embodiments of the present disclosure, and also indicate a successive sequence.

“At least one of” in the present disclosure can also be described as one or more, and “a plurality of” can indicate two, three, four, or more, which is not limited in the present disclosure. In the embodiments of the present disclosure, technical features in a kind of technical features are distinguished by “first”, “second”, “third”, “A”, “B”, “C”, and “D”, and there is no successive sequence or magnitude sequence among the technical features described by “first”, “second”, “third”, “A”, “B”, “C”, and “D”.

Correspondence relations shown in each table of the present disclosure can be configured or pre-defined. Values of information in each table are merely illustrative, and can be configured as other values, which are not limited in the present disclosure. When a correspondence relation between the information and each parameter is configured, it is not necessarily required to configure all the correspondence relations indicated in each table. For example, in the table of the present disclosure, the corresponding relations shown in some rows may not be configured. For another example, appropriate variation and adjustment, such as splitting and merging, can be made based on the above table. The name of the parameter shown in the title of each table can also employ other names that are understandable by the communication device, and the value or expression mode of the parameter can also employ other values or expression modes that are understandable by the communication device. When implemented, each table can also employ other data structures, such as an array, a queue, a container, a stack, a linear table, a pointer, a linked list, a tree, a graph, a structural body, a class, a heap, and a hash table.

Pre-defining in the present disclosure can be interpreted as defining, pre-defining, storing, pre-storing, pre-negotiating, pre-configuring, firming, or pre-firing.

Those of ordinary skill in the art can appreciate that the units and algorithm steps in all instances described in combination with the embodiments disclosed here can be implemented through electronic hardware, or combinations of computer software and electronic hardware. Whether these functions are executed through hardware or software depends on the particular application of the technical solution and design constraint conditions. Those skilled in the art can implement the functions described through different methods for each particular application, but such an implementation should not be deemed as falling beyond the scope of the present disclosure.

Those skilled in the art can clearly understand that for convenience and brevity of description, reference can be made to the corresponding processes in the foregoing method embodiment for specific operating processes of the above system, device, and unit, which will not be repeated here.

What are described above are merely the particular implementations of the present disclosure, but which is not intended to limit the scope of protection of the present disclosure. Changes or substitutions that can be readily conceived by those skilled in the art within the technical scope disclosed by the present disclosure should fall within the scope of protection of the present disclosure. Thus, the scope of protection of the present disclosure should be defined by the scope of protection of the claims.

1. A method for exchanging path switching capability, performed by a first terminal device, the method comprising:
sending a request message for establishing a direct communication to a second terminal device, wherein the request message for establishing the direct communication indicates path switching capability of the first terminal device; and
receiving a response message for establishing the direct communication sent by the second terminal device, wherein the response message for establishing the direct communication indicates path switching capability of the second terminal device.

2. The method according to claim 1, wherein the request message for establishing the direct communication comprises an indication of the path switching capability of the first terminal device, wherein the indication of the path switching capability of the first terminal device indicates whether the first terminal device supports at least one of a PC5 direct communication or a Uu direct communication; and
the response message for establishing the direct communication comprises an indication of the path switching capability of the second terminal device, wherein the indication of the path switching capability of the second terminal device indicates whether the second terminal device supports at least one of the PC5 direct communication or the Uu direct communication.

3. The method according to claim 2, wherein the indication of the path switching capability comprises at least one of first indication information or second indication information; and
the first indication information indicates whether a corresponding terminal device supports the PC5 direct communication; and the second indication information indicates whether the corresponding terminal device supports the Uu direct communication.

4. The method according to claim 1, wherein in a case where the request message for establishing the direct communication comprises an indication of the path switching capability of the first terminal device, the request message for establishing the direct communication indicates that the first terminal device supports at least one of a PC5 direct communication or a Uu direct communication; and
in a case where the request message for establishing the direct communication does not comprise the indication of the path switching capability of the first terminal device, the request message for establishing the direct communication indicates that the first terminal device does not support the PC5 direct communication or the Uu direct communication.

5. The method according to claim 1, wherein in a case where the response message for establishing the direct communication comprises an indication of the path switching capability of the second terminal device, the response message for establishing the direct communication indicates that the second terminal device supports at least one of a PC5 direct communication or a Uu direct communication; and
in a case where the response message for establishing the direct communication does not comprise the indication of the path switching capability of the second terminal device, the response message for establishing the direct communication indicates that the second terminal device does not support the PC5 direct communication or the Uu direct communication.

6. The method according to claim 4, wherein in a case where the indication of the path switching capability comprises third indication information, the indication of the path switching capability indicates that a corresponding terminal device supports the PC5 direct communication; and
in a case where the indication of the path switching capability does not comprise the third indication information, the indication of the path switching capability indicates that the corresponding terminal device does not support the PC5 direct communication.

7. The method according to claim 4, wherein in a case where the indication of the path switching capability comprises fourth indication information, the indication of the path switching capability indicates that a corresponding terminal device supports the Uu direct communication; and
in a case where the indication of the path switching capability does not comprise the fourth indication information, the indication of the path switching capability indicates that the corresponding terminal device does not support the Uu direct communication.

8. The method according to claim 1, wherein the request message for establishing the direct communication and the response message for establishing the direct communication are configured to establish a PC5 direct communication path between the first terminal device and the second terminal device.

9. The method according to claim 8, further comprising:
determining whether to switch from the PC5 direct communication path to a Uu direct communication path, according to the path switching capability of the first terminal device and the path switching capability of the second terminal device;
wherein determining whether to switch from the PC5 direct communication path to the Uu direct communication path, according to the path switching capability of the first terminal device and the path switching capability of the second terminal device comprises:
determining to switch from the PC5 direct communication path to the Uu direct communication path, in a case where the first terminal device supports a Uu direct communication and the second terminal device supports the Uu direct communication; and
determining not to switch from the PC5 direct communication path to the Uu direct communication path in a case where the first terminal device does not support the Uu direct communication, or the second terminal device does not support the Uu direct communication.

10. (canceled)

11. A method for exchanging path switching capability, performed by a second terminal device, the method comprising:
receiving a request message for establishing a direct communication sent by a first terminal device, wherein the request message for establishing the direct communication indicates path switching capability of the first terminal device; and
sending a response message for establishing the direct communication to the first terminal device, wherein the response message for establishing the direct communication indicates path switching capability of the second terminal device.

12. The method according to claim 11, wherein the request message for establishing the direct communication comprises an indication of the path switching capability of the first terminal device, and indication of the path switching capability of the first terminal device indicates whether the first terminal device supports at least one of a PC5 direct communication or a Uu direct communication; and
the response message for establishing the direct communication comprises an indication of the path switching capability of the second terminal device, and the indication of the path switching capability of the second terminal device indicates whether the second terminal device supports at least one of the PC5 direct communication or the Uu direct communication.

13. The method according to claim 12, wherein the indication of the path switching capability comprises at least one of first indication information or second indication information; and
the first indication information indicates whether a corresponding terminal device supports the PC5 direct communication; and the second indication information indicates whether the corresponding terminal device supports the Uu direct communication.

14. The method according to claim 11, wherein in a case where the request message for establishing the direct communication comprises an indication of the path switching capability of the first terminal device, the request message for establishing the direct communication indicates that the first terminal device supports at least one of a PC5 direct communication or a Uu direct communication; and
in a case where the request message for establishing the direct communication does not comprise the indication of the path switching capability of the first terminal device, the request message for establishing the direct communication indicates that the first terminal device does not support the PC5 direct communication or the Uu direct communication.

15. The method according to claim 11, wherein in a case where the response message for establishing the direct communication comprises an indication of the path switching capability of the second terminal device, the response message for establishing the direct communication indicates that the second terminal device supports at least one of a PC5 direct communication or a Uu direct communication; and
in a case where the response message for establishing the direct communication does not comprise the indication of the path switching capability of the second terminal device, the response message for establishing the direct communication indicates that the second terminal device does not support the PC5 direct communication or the Uu direct communication.

16. The method according to claim wherein in a case where the indication of the path switching capability comprises third indication information, the indication of the path switching capability indicates that a corresponding terminal device supports the PC5 direct communication; and
in a case where the indication of the path switching capability does not comprise the third indication information, the indication of the path switching capability indicates that the corresponding terminal device does not support the PC5 direct communication.

17. The method according to claim wherein in a case where the indication of the path switching capability comprises fourth indication information, the indication of the path switching capability indicates that a corresponding terminal device supports the Uu direct communication; and
in a case where the indication of the path switching capability does not comprise the fourth indication information, the indication of the path switching capability indicates that the corresponding terminal device does not support the Uu direct communication.

18. The method according to claim 11, wherein the request message for establishing the direct communication and the response message for establishing the direct communication are configured to establish a PC5 direct communication path between the first terminal device and the second terminal device.

19. The method according to claim 18, further comprising:
determining whether to switch from the PC5 direct communication path to a Uu direct communication path, according to the path switching capability of the first terminal device and the path switching capability of the second terminal device;
wherein determining whether to switch from the PC5 direct communication path to the Uu direct communication path, according to the path switching capability of the first terminal device and the path switching capability of the second terminal device comprises:
determining to switch from the PC5 direct communication path to the Uu direct communication path, in a case where the first terminal device supports a Uu direct communication and the second terminal device supports the Uu direct communication; and
determining not to switch from the PC5 direct communication path to the Uu direct communication path, in a case where the first terminal device does not support the Uu direct communication, or the second terminal device does not support the Uu direct communication.

20-22. (canceled)

23. A communication device, comprising:
one or more processors; and
a memory that stores a computer program, wherein the one or more processors, when collectively configured to execute the computer program stored in the memory, cause the communication device to:
send a request message for establishing a direct communication to a second terminal device, wherein the request message for establishing the direct communication indicates path switching capability of the communication device; and
receive a response message for establishing the direct communication sent by the second terminal device, wherein the response message for establishing the direct communication indicates path switching capability of the second terminal device.

24. A communication device, comprising:
one or more processors; and
a memory that stores a computer program, wherein the one or more processors, when collectively configured to execute the computer program stored in the memory, cause the communication device to perform the method according to claim 11.

25-29. (canceled)
